(19) United States
(12) Patent Application Publication
(10) Pub. No.: US 2008/0053988 A1
(43) Pub. Date: Mar. 6, 2008

(54) Plasma generation apparatus and workpiece processing apparatus using the same

(75) Inventors: Kiyotaka Arai, Wakayama-shi (JP); Hirofumi Mankawa, Wakayama-shi (JP); Hidetaka Matsuuchi, Wakayama-shi (JP); Ryuichi Iwasaki, Wakayama-shi (JP); Kazuhiro Yoshida, Wakayama-shi (JP); Shigeru Masuda, Wakayama-shi (JP); Hirofumi Hayashi, Wakayama-shi (JP); Masaaki Mike, Wakayama-shi (JP)

Correspondence Address: JORDAN AND HAMBURG LLP, 122 EAST 42ND STREET, SUITE 4000, NEW YORK, NY, 10168, US

(73) Assignee: NORITSU KOKI CO., LTD., Wakayama-shi (JP)

(21) Appl. No.: 11/895,706

(22) Filed: Aug. 27, 2007

(30) Foreign Application Priority Data
Aug. 30, 2006 (JP) 2006-233710
Aug. 30, 2006 (JP) 2006-233711
Aug. 30, 2006 (JP) 2006-233712

(51) Int. Cl. H05B 6/68

(52) U.S. Cl. 219/680; 219/121.36; 219/687; 219/710

(57) ABSTRACT

Disclosed is a plasma generation apparatus, which comprises a microwave generation section adapted to generate a microwave, a gas supply section adapted to supply a gas to be plasmatized, a plasma generation nozzle which is provided with an inner electrode adapted to receive the microwave and an outer electrode concentrically disposed outside the inner electrode, and adapted to plasmatize the gas supplied from the gas supply section thereinto, based on energy of the microwave, and emit the plasmatized gas from a distal end thereof; and an adapter attached to the distal end of the plasma generation nozzle. In the plasma generation apparatus, the inner and outer electrodes of the plasma generation nozzle are disposed to allow a glow discharge to be induced therebetween so as to plasmatize the gas in a space defined therebetween, and, according to a new supply of the gas into the space, emit the plasmatized gas under atmospheric pressures from a ring-shaped spout of the space in the distal end of the plasma generation nozzle. The adapter is adapted to convert the ring-shaped spout to a lengthwise spout thereof.

### BACKGROUND OF THE INVENTION

1. Field of the Invention

The present invention relates to a plasma generation apparatus for emitting plasma toward a target workpiece, such as a substrate, so as to carry out cleaning, modification or other processing of a surface of the workpiece. The present invention also relates to a workpiece processing apparatus using the plasma generation apparatus.

2. Description of the Background Art

There has been known a workpiece processing apparatus designed to expose a target workpiece, such as a semiconductor substrate, to plasma so as to carry out a processing of a surface of the workpiece, such as removal of organic contaminants on the surface, modification of the surface, etching of the surface, or formation or removal of a thin film on the surface. For example, JP 2003-197397A (Publication 1) discloses a plasma processing apparatus using a plasma generation nozzle including an inner conductive member and an outer conductive member which are disposed in concentric relation to each other, wherein a high-frequency pulsed electric field is applied between the inner and outer conductive members so as to induce a glow discharge therebetween without an arc discharge to generate plasma. With a view to obtaining high-density plasma under atmospheric pressures, this apparatus is designed to allow a processing gas from a gas supply source to be directed from a base end to a free end of the nozzle while being swirled in a space defined between the inner and outer conductive members, so as to produce high-density plasma and emit the plasma from the free end toward a target workpiece.

While the plasma generation nozzle disclosed in the Publication 1 has a configuration suitable for generating high-density plasma under atmospheric pressures, it has difficulty in processing a target workpiece having a relatively large surface area or treating a plurality of target workpieces all together, in a suitable manner. Specifically, in the large-surface area workpiece, the emitted plasma is more likely to be cooled and vanished before reaching a desired exposure position of the workpiece. Thus, in consideration of a plasma exposure for a large-surface area workpiece, the nozzle has to be formed to have a relatively large diameter. This means a need for generating a microwave electric field with higher intensity, which causes undesirable increases in cost and noise caused by plasma generation. Moreover, the large-diameter nozzle is liable to unevenly induce the glow discharge therein to cause difficulty in ensuring adequate controllability.

From this point of view, JP 2004-006211A (Publication 2) discloses a plasma processing apparatus comprising two strip-shaped electrodes disposed in parallel relation to each other to serve, respectively, as an electric field-applying electrode and an earth electrode, wherein a processing gas is supplied into a plasma generation space defined by surrounding lateral sides of the electrodes, and ionized to a plasma state (i.e., plasmatized). The plasmatized processing gas is emitted from a slit-shaped spout formed longitudinally in the earth electrode, toward a workpiece. In the apparatus disclosed in the Publication 2, the slit-shaped spout can emit plasma therefrom to allow a surface of the workpiece to be widely exposed to the plasma.

Although the apparatus disclosed in the Publication 2 has a potential for allowing a surface of the workpiece to be exposed to the plasmatized processing gas relatively evenly and widely, the glow discharge device based on the parallel flat-plate electrodes involves problems about a need for high discharge voltage, an increase in cost and instability of discharge characteristics. Moreover, the glow discharge device is highly likely to locally induce an arc discharge. Thus, it is necessary to coat at least one of the electrodes with a dielectric material so as to suppress the occurrence of arc discharge, and thereby the discharge voltage has to be further increased. In terms of plasma generation, it can be said that the apparatus disclosed in the Publication 1 is superior to the apparatus disclosed in the Publication 2.

### SUMMARY OF THE INVENTION

In view of the above circumstances, it is an object of the present invention to provide a plasma generation apparatus capable of exposing a large-surface area workpiece evenly to plasma, even using a low-cost, easily-controlled plasma generation nozzle comprising an inner electrode and an outer electrode which are disposed in concentric relation to each other. It is another object of the present invention to provide a workpiece processing apparatus using the plasma generation apparatus.

In order to achieve the above objects, according to a first aspect of the present invention, there is provided a plasma generation apparatus comprising: a microwave generation section adapted to generate a microwave; a gas supply section adapted to supply a gas to be plasmatized; a plasma generation nozzle which includes an inner electrode adapted to receive the microwave, and an outer electrode concentrically disposed outside the inner electrode , wherein the plasma generation nozzle is adapted to plasmatize the gas supplied from the gas supply section thereinto, based on energy of the microwave, and emit the plasmatized gas from a distal end thereof; and an adapter attached to the distal end of the plasma generation nozzle. In this plasma generation apparatus, the inner and outer electrodes of the plasma generation nozzle are disposed to allow a glow discharge to be induced therebetween so as to plasmatize the gas in a space defined therebetween, and, according to a new supply of the gas into the space, emit the plasmatized gas under atmospheric pressures from a ring-shaped spout of the space in the distal end of the plasma generation nozzle, and the adapter is adapted to convert the ring-shaped spout to a lengthwise spout thereof.

According to a second aspect of the present invention, there is provided a plasma generation apparatus based on the plasma generation apparatus set forth in the first aspect of the present invention. Specifically, in addition to the features of this the plasma generation apparatus set forth in the first aspect of the present invention, this plasma generation apparatus comprises a plurality of the above plasma generation nozzles, and a waveguide adapted to propagate microwave generated by the above microwave generation section, wherein the plurality of plasma generation nozzles are attached to the waveguide in such a manner as to be arranged in an array.

According to a third aspect of the present invention, there is provided a workpiece processing apparatus for exposing a workpiece to plasma so as to subject the workpiece to a predetermined processing, which comprises a plasma generation apparatus adapted to emit a plasmatized gas in a predetermined direction relative to the workpiece, and a moving mechanism adapted to cause relative movement between the workpiece and the plasma generation apparatus, in a plane intersecting the ejection direction of the plasmatized gas. The plasma generation apparatus has the features of the plasma generation apparatus set forth in either one of the first and second aspect of the present invention.

### BRIEF DESCRIPTION OF THE DRAWINGS

FIG. 1 is a perspective view showing a general structure of a workpiece processing apparatus according to a first embodiment of the present invention.

FIG. 2 is a perspective view showing a plasma generation unit, when viewed from a direction different from that in FIG. 1.

FIG. 3 is a partially cut-out side view showing the workpiece processing apparatus.

FIG. 4 is an enlarged sectional view showing a plasma generation nozzle and an adapter in the plasma generation apparatus.

FIG. 5 is an exploded perspective view showing the adapter.

FIG. 6 is an enlarged perspective view showing a mounting region of a waveguide for the array of plasma generation nozzles with the adapters.

FIG. 7 is a sectional view schematically showing a function of the adapter.

FIGS. 8A to 8C are explanatory diagrams showing various examples of the configuration of a spout in the adapter.

FIG. 9 is a block diagram showing a control system of the workpiece processing apparatus according to the first embodiment.

FIGS. 10 and 11 are explanatory diagrams showing two different arrangements of the plasma generation nozzles with the adaptors, in examples of modification of the workpiece processing apparatus according to the first embodiment.

FIG. 12 is an enlarged sectional view showing a mounting portion of a waveguide for a plasma generation nozzle with an adapter, in a workpiece processing apparatus according to a second embodiment of the present invention.

FIG. 13 is an exploded perspective view showing the adapter in the workpiece processing apparatus according to the second embodiment.

FIG. 14 is a block diagram showing a control system of the workpiece processing apparatus according to the second embodiment.

FIG. 15 is an enlarged sectional view showing a mounting portion of a waveguide for a plasma generation nozzle with an adapter, in a workpiece processing apparatus according to a third embodiment of the present invention.

FIG. 16 is an exploded perspective view showing the adapter in the workpiece processing apparatus according to the third embodiment.

### DESCRIPTION OF THE PREFERRED EMBODIMENTS

With reference to the drawings, several preferred embodiment of the present invention will now be specifically described.

### First Embodiment

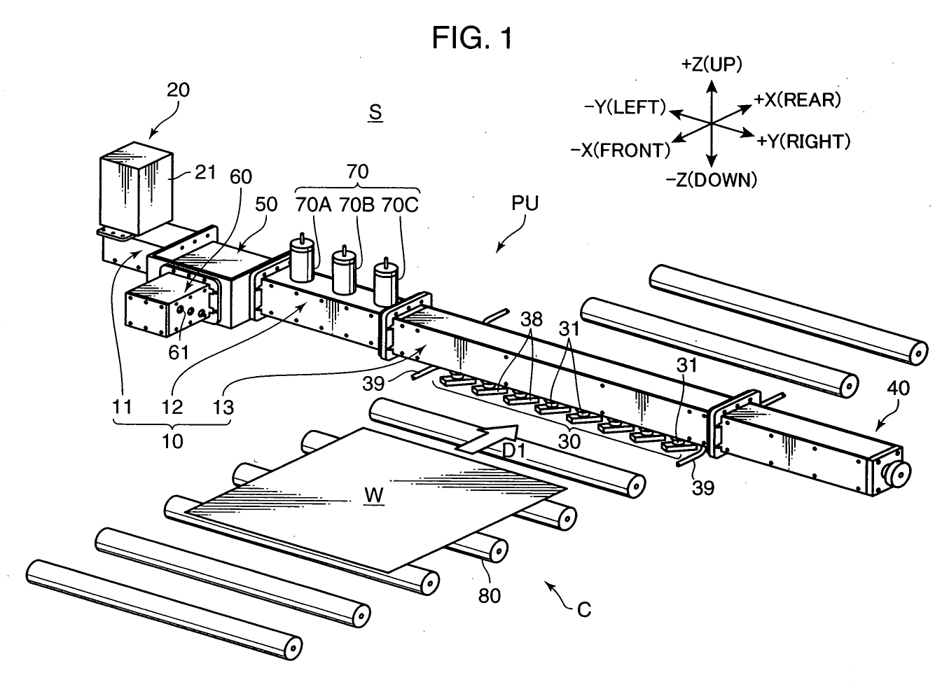

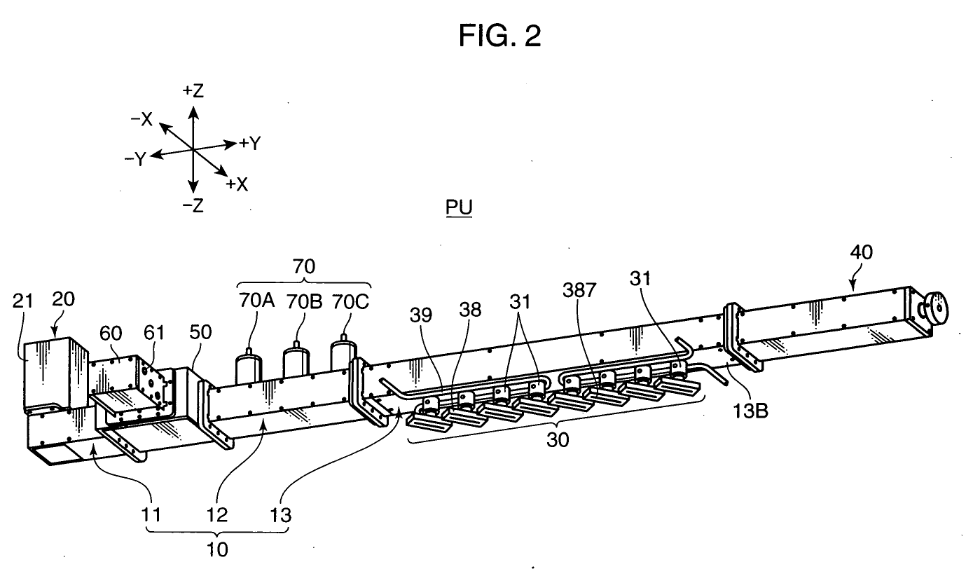

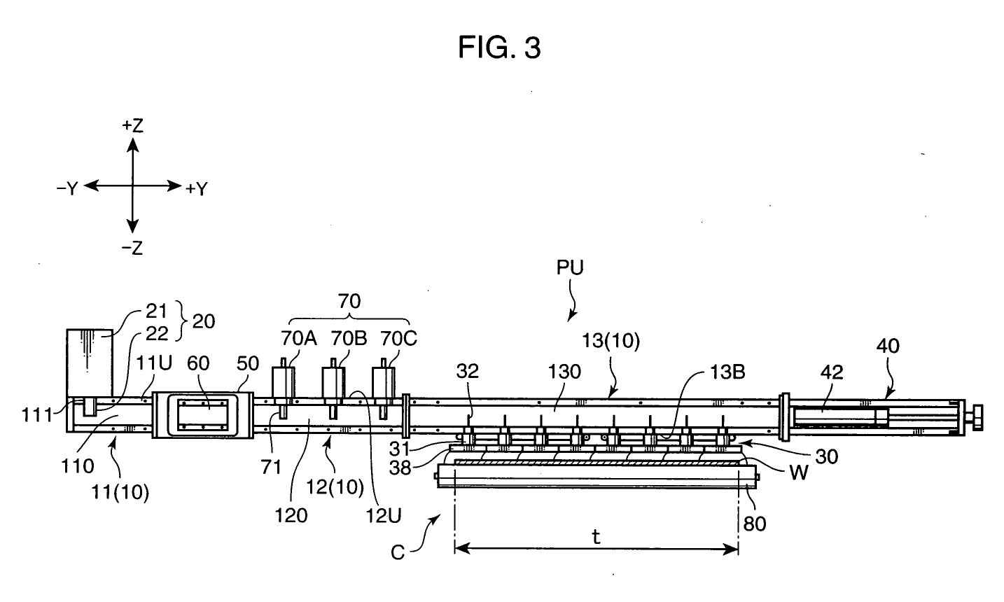

FIG. 1 is a perspective view showing a general structure of a workpiece processing apparatus S according to a first embodiment of the present invention. This workpiece processing apparatus S comprises a plasma generation unit PU (plasma generation apparatus) for generating plasma and emitting the plasma toward a workpiece W (i.e., a target object to be subjected to a plasma processing), and a carrying mechanism C (moving mechanism) for carrying the workpiece W along a predetermined route passing through an exposure zone of the plasma. FIG. 2 is a perspective view of the plasma generation unit PU when viewed from a direction different from that in FIG. 1, and FIG. 3 is a partially cut-out side view of the workpiece processing apparatus S. The following description will be made on the assumption that X-X direction, Y-Y direction and Z-Z direction in FIGS. 1 to 3 are, respectively, a frontward/rearward (longitudinal) direction, a rightward/leftward (lateral) direction and an upward/downward (vertical) direction, and −X direction, +X direction, −Y direction, +Y direction, −Z direction and +Z direction in FIGS. 1 to 3 are, respectively, a frontward direction, a rearward direction, a leftward direction, a rightward direction, a downward direction and an upward direction.

The plasma generation unit PU is designed to generate plasma under atmospheric pressures and ambient temperatures through the use of a microwave. The plasma generation unit PU generally comprises: a waveguide 10 adapted to propagate a microwave; a microwave generation device 20 disposed at one end (left end) of the waveguide 10 and adapted to generate a microwave having a predetermined wavelength; a plasma generation section 30 provided to the waveguide 10; a sliding short 40 disposed at the other end (right end) of the waveguide 10 and adapted to reflect a microwave; a circulator 50 adapted to separate a reflected microwave from a microwave radiated into the waveguide 10 so as to prevent the reflected microwave from returning to the microwave generation device 20; a dummy load 60 adapted to absorb the reflected microwave separated by the circulator 50; and a stub tuner 70 adapted to perform impedance matching between the waveguide 10 and an after-mentioned plasma generation nozzle 31. The carrying mechanism C comprises a plurality of carrier rollers 80 adapted to be rotationally driven by a drive mechanism (not shown). This embodiment will be described based on one example where a flat plate-shaped workpiece W is carried by the carrying mechanism C.

The waveguide 10 is made of a non-magnetic metal, such as aluminum, and formed to have a sectionally-rectangular long tube shape. The waveguide 10 is adapted to propagate a microwave generated by the microwave generation device 20, toward the plasma generation section 30 along a longitudinal direction of the waveguide 10. The waveguide 10 is formed as a connected body in which a plurality of divided waveguide pieces are connected together through respective flanges thereof. Specifically, a first waveguide piece 11 having the microwave generation device 20 mounted thereon, a second waveguide piece 12 having the stub tuner 70 assembled thereto, and a third waveguide piece 13 provided with the plasma generation section 30, are disposed in turn from the left end of the waveguide 10, and connected together to form the connected body. More specifically, the circulator 50 is interposed between the first waveguide piece 11 and the second waveguide piece 12, and the sliding short 40 is connected to a right end of the third waveguide piece 13.

Each of the first waveguide piece 11, the second waveguide piece 12 and the third waveguide piece 13 are formed in an angular tube shape by assembling four metal flat plates consisting of a top plate, a bottom plate and two side plates, together, and a flange plate is attached to each of opposite ends of the assembly. Instead of the waveguide formed by assembling a plurality of flat plates, a plurality of rectangular waveguide pieces or a non-split type waveguide may be formed directly by an extrusion process or a bending process of a plate-shaped member. Further, the material of the waveguide 10 is not limited to the non-magnetic metal, but the waveguide 10 may be made of any other suitable material having a waveguide function.

The microwave generation device 20 comprises a device body section 21 having a microwave generation source, such as a magnetron adapted to generate a microwave, for example, of 2.45 GHz, and a microwave-transmitting antenna 22 adapted to radiate a microwave generated by the device body section 21, to an internal space of the waveguide 10. In the first the embodiment, a continuously-variable type microwave generation device capable of outputting microwave energy, for example, of 1 W to 3 kW, is suitably used as the microwave generation device 20.

As shown in FIG. 3, the microwave generation device 20 is a type in which the microwave-transmitting antenna 22 protrudes from the device body section 21. The microwave generation device 20 is fixed to the waveguide 10 in such a manner as to be placed on the first waveguide piece 11. Specifically, the device body section 21 is placed on a top plate 11U of the first waveguide piece 11, and fixed in such a manner that the microwave-transmitting antenna 22 protrudes into a waveguide space 110 inside the first waveguide piece 11, through a through-hole 111 formed in the top plate 11U. Based on this structure, a microwave, for example, of 2.45 GHz, radiated from the microwave-transmitting antenna 22, can be propagated through the waveguide 10 from one (left) end toward the other (right) end of the waveguide 10.

The plasma generation section 30 comprises a plurality (in the first embodiment, eight) of plasma generation nozzles 31 which are arranged in spaced-apart relation to each other along a propagation direction (lateral direction) of a microwave, and attached to a bottom plate 13B (i.e., a surface opposed to a target workpiece) of the third waveguide piece 13. The plasma generation section 30 (i.e., the array of eight plasma generation nozzles 31) has a width (i.e., lateral width) approximately equal to a lateral size t (i.e., a size in a direction orthogonal to a carrying direction) of the flat plate-shaped workpiece W. This makes it possible to subject an entire surface (opposed to the bottom plate 13B) of the workpiece W to a plasma processing while carrying the workpiece W by the carrier rollers 80.

Preferably, the plasma generation nozzles 31 are arranged at given intervals determined depending on a wavelength λG of a microwave to be propagated through the waveguide 10. For example, the plasma generation nozzles 31 may be arranged at ½ pitch or ¼ pitch of the wavelength λG More specifically, when a microwave of 2.45 GHz is used, the wavelength λG is 230 mm. Thus, the plasma generation nozzles 31 may be arranged at a pitch of 115 mm (λG/2) or 57.5 mm (λG/4).

Further, an adapter 38 is attached to a distal end of each of the plasma generation nozzles 31, as described in detail later.

The sliding short 40 is provided as a means to optimize a coupling state in which a center conductive member 32 in each of the plasma generation nozzles 31 captures a microwave propagated through the waveguide 10. The sliding short 40 is connected to the right end of the third waveguide piece 13 to change a reflection position of the microwave so as to adjust a standing wave pattern. Thus, in case of utilizing no standing wave, a dummy load having a wave absorbing function is attached in place of the sliding short 40. This sliding short 40 is internally provided with a cylindrical-shaped reflection block 42, and adapted to slidingly move the reflection block 42 in the lateral direction so as to optimize a standing wave pattern.

The circulator 50 is composed, for example, of a waveguide-type 3-port circulator incorporating a ferrite column. The circulator 50 is operable, when a microwave propagated toward the plasma generation section 30 is reflected and partly retuned toward the microwave generation device 20 without energy consumption by the plasma generation section 30, to direct the reflected microwave to the dummy load 60 without retuning it to the microwave generation device 20. The circulator 50 can prevent the microwave generation device 20 from being excessively heated by the reflected microwave.

The dummy load 60 is a water-cooled (or air-cooled) wave absorber adapted to absorb the reflected microwave and concert it to heat. The dummy load 60 is provided with a cooling-water passage 61 for allowing cooling water to pass therethrough so as to allow the heat converted from the reflected microwave to be transferred to the cooling water in a heat-exchanging manner.

The stub tuner 70 serves as a means to perform impedance matching between the waveguide 10 and each of the plasma generation nozzles 31. In the first embodiment, three stub tuner units 70A to 70C are attached to a top plate 12U of the second waveguide piece 12 in an in-line arrangement at predetermined intervals. Each of the three stub tuner units 70A to 70C has the same structure designed such that a stub 71 protruding into a waveguide space 120 of the second waveguide piece 12 as shown in FIG. 3 is moved between a protruding position and a retracted position so as to maximize energy consumption by the center conductive members 32, i.e., minimize reflected microwave energy, to facilitate plasma ignition.

The carrying mechanism C has the plurality of carrier rollers 80 arranged along a predetermined carrying path. The carrier rollers 80 are adapted to be driven by the drive mechanism (not shown) so as to carry a target workpiece W (i.e., workpiece to be to be subjected to a plasma processing) through the plasma generation section 30. For example, the target workpiece W may include a flat substrate, such as a plasma display panel or semiconductor substrate, and a printed circuit board with electronic components mounted thereon. Further, the target workpiece may include a non-flat part and a non-flat assembly. In this case, instead of the carrier rollers, another type of carrying mechanism, such as a belt conveyer, may be employed.

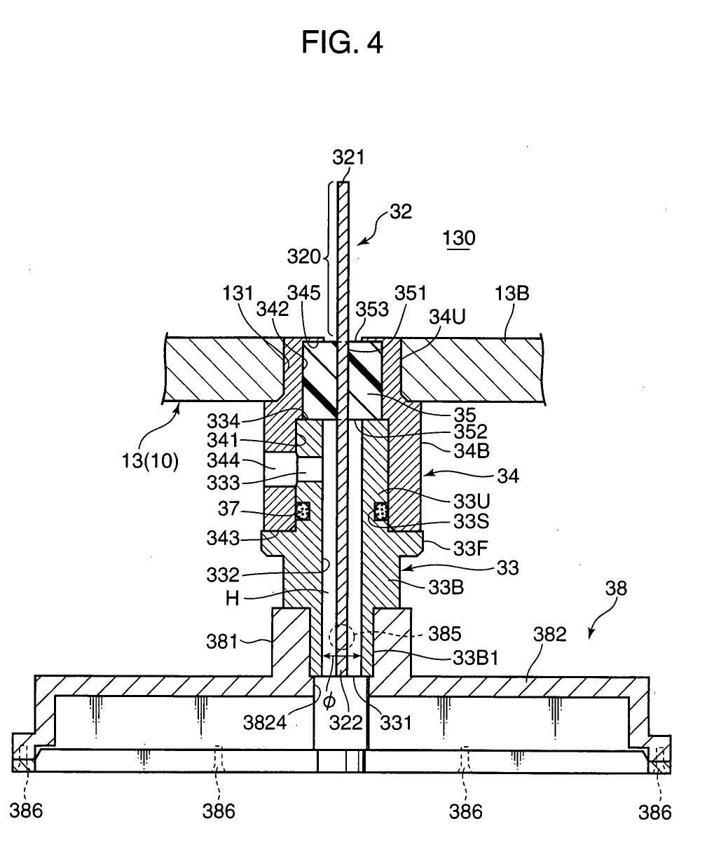

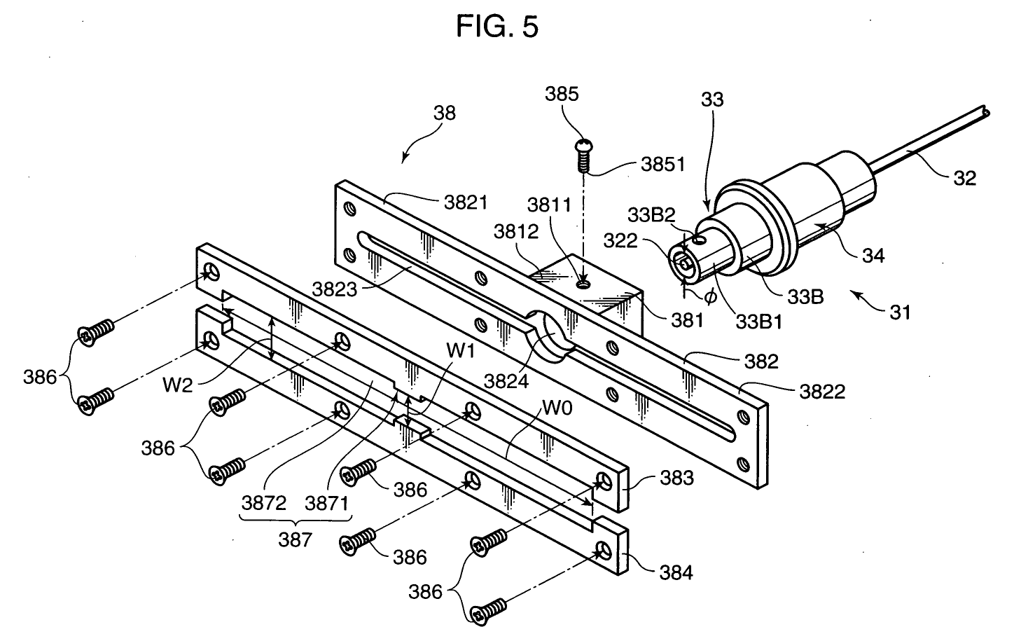

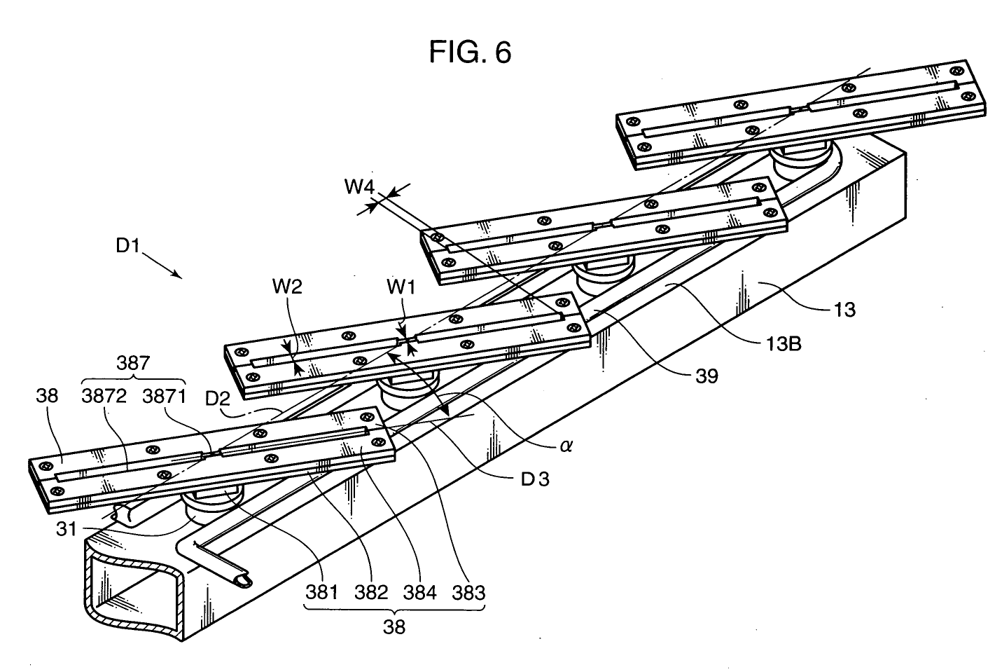

With reference to FIGS. 4 to 6, the plasma generation nozzles 31 and the adapter 38 attached to the distal end of each of the plasma generation nozzles 31 will be specifically described. FIG. 4 is an enlarged sectional view showing the plasma generation nozzle 31 and the adapter 38. FIG. 5 is an exploded perspective view of the adapter 38, and FIG. 6 is an enlarged perspective view showing a mounting portion of the third waveguide piece 13 for the array of plasma generation nozzles 31 with the adapters 38. Each of the plasma generation nozzles 31 comprises the center conductive member 32 (serving as an inner electrode), a nozzle body 33 (serving as an outer electrode) disposed outside the center conductive member 32 and in concentric and spaced-apart relation thereto, a nozzle holder 34 and a sealing member 35.

The center conductive member 32 is made of a highly electrically conductive metal, such as copper, aluminum or brass, and formed as a rod-shaped member having a diameter of about 1 to 5 mm. The center conductive member 32 is disposed vertically to have an upper end 321 which penetrates the bottom plate 13B of the third waveguide piece 13 and protrudes into a waveguide space 130 of the third waveguide piece 13 by a predetermined length (this protruding portion will hereinafter be referred to as “receiving antenna portion 320”), and a lower end 322 which is approximately flush with a lower edge 331 of the nozzle body 33. Thus, a microwave propagated through the waveguide 10 is received by the receiving antenna portion 320, so as to provide microwave energy (microwave power) to the center conductive member 32. The center conductive member 32 has a longitudinally approximately-central portion held by the sealing member 35.

The nozzle body 33 is made of a highly electrically conductive metal, and formed as a tubular-shaped member having a columnar space 332 which houses the center conductive member 32. The nozzle holder 34 is also made of a highly electrically conductive metal, and formed as a tubular-shaped member having a relatively-large-diameter lower holding space 341 which holds the nozzle body 33, and a relatively-small-diameter upper holding space 342 which holds the sealing member 35. The sealing member 35 is made of a heat-resistant resin material, such as Teflon (which is a registered trademark), or an electrical insulation material, such as ceramic material, and formed as a tubular-shaped member having a holding hole 351 which extends along an axis of the plasma generation nozzle 31 to fixedly hold the center conductive member 32.

The nozzle body 33 has, in order from the top thereof, an upper body portion 33U fitted in the lower holding space 341 of the nozzle holder 34, an annular-shaped concave portion 33S holding an after-mentioned gas-sealing ring 37, a flange portion 33F protruding annularly, and a lower body portion 33B protruding from the nozzle holder 34. The upper body portion 33U is formed with a communication hole 333 for supplying a predetermined processing gas into the columnar space 332.

The nozzle body 33 serves as an outer conductive member disposed around the center conductive member 32, and the center conductive member 32 is inserted into the columnar space 332 along the axis while ensuring a given ring-shaped space H (insulating space) therearound. The nozzle body 33 is fitted into the nozzle holder 34 in such a manner that an upper surface of the flange portion 33F comes into contact with a lower edge 343 of the nozzle holder 34. Preferably, the nozzle body 33 is detachably fixed to the nozzle holder 34 by use, for example, of a plunger or a set screw.

The nozzle holder 34 has an upper body portion 34U (approximately corresponding to the upper holding space 342) tightly fitted in a through-hole 131 formed in the bottom plate 13B of the third waveguide piece 13, and a lower body portion 34B (approximately corresponding to the upper holding space 341) extending downwardly from the bottom plate 13B. A cooling pipe line 39 (see FIGS. 1 to 3) is arranged on and along the bottom plate 13B of the third waveguide piece 13 to come into contact with the lower body portion 34B so as to dissipate heat therefrom.

The lower body portion 34B is formed with a gas supply hole 344 penetrating from an outer peripheral surface to inner peripheral surface thereof to supply the processing gas into the ring-shaped space H. Although not shown, a pipe joint is attached to the gas supply hole 344 to allow a terminal end of a gas supply pipe for supplying the predetermined processing gas to be connected thereto. The gas supply hole 344 of the nozzle holder 34 and the communication hole 333 of the nozzle body 33 are formed at respective positions to come into communication with each other when the nozzle body 33 is fitted into the nozzle holder 34 in place. In order to prevent gas leakage from a butted portion between the gas supply hole 344 and the communication hole 333, a gas-sealing ring 37 is provided between the nozzle body 33 and the nozzle holder 34.

The combination hole consisting of the gas supply hole 344 and the communication hole 333 may be formed in a plural number along a circumferential direction of the plasma generation nozzle 31 at even intervals. Further, instead of forming the combination hole to extend radially toward the axis, the combination hole may be formed to extend in a tangential direction relative to an outer peripheral surface of the columnar space 332 so as to form a swirl flow of the processing gas. Furthermore, instead of forming the combination hole to extend in a direction perpendicular to the center conductive member 32, the combination hole may be formed to extend obliquely from the side of the upper end 321 toward the side of the lower end 322 so as to provide a smooth flow of the processing gas.

The sealing member 35 is held in the upper holding space 342 of the nozzle holder 34 in such a manner that it has a lower edge 352 in contact with an upper edge 334 of the nozzle body 33, and an upper edge 353 in contact with an upper stopper portion 345 of the nozzle holder 34. Specifically, in an assembling operation, the sealing member 35 supporting the center conductive member 32 is fitted into the upper holding space 342, and then the nozzle body 33 is fitted into the lower holding space 341 in such a manner as to press the lower edge 352 of the sealing member 35 by the upper edge 334 thereof.

The plasma generation nozzle 31 is constructed as above. That is, the nozzle body 33, the nozzle holder 34 and the third waveguide piece 13 are placed in a conduction state (the same potential). Differently from these members, the center conductive member 32 is supported by the electrically-insulating sealing member 35, and thereby electrically insulated from the above members. Thus, when a microwave is received by the receiving antenna portion 320 of the center conductive member 32 and thereby a microwave power is supplied to the center conductive member 32, an electric field concentration region will be formed around the lower end 322 of the center conductive member 32 and the lower edge 331 of the nozzle body 33.

In the state, when an oxygen-based processing gas, such as oxygen gas or air, is supplied into the ring-shaped space H, the processing gas is excited by the microwave power, so that plasma (ionized gas) is generated around the lower end 322 of the center conductive member 32. This plasma is reactive plasma which has a gas temperature close to ambient temperatures while an electron temperature is several tens of thousands of degrees (the reactive plasma has an extremely high electron temperature indicated by electrons therein, as compared with a gas temperature indicated by neutrons therein), and is generated under atmospheric pressures.

According to a new gas flow supplied from the gas supply hole 344, the plasmatized processing gas is emitted from the lower edge 331 of the nozzle body 33 in the form of a plume. This plume includes radicals. For example, if an oxygen-based gas is used as the processing gas, oxygen radicals can be generated to form a plume having a function of decomposing/removing organic substances, a function of removing a resist film or the like. The plasma generation unit PU according to the first embodiment includes the array of plasma generation nozzles 31. Thus, a line-shaped plume extending in the lateral direction can be generated.

As the processing gas, an inert gas, such as argon gas, or nitrogen gas, can be used for carrying out cleaning or modification of a substrate surface. Further, a compound gas containing fluorine can be used for modifying a substrate surface to a water-repellant surface, and a compound gas containing a hydrophilic group can be used for modifying a substrate surface to a hydrophilic surface. Furthermore, a compound gas containing a metal element can be used for forming a metal thin film on a substrate.

The adapter 38 is adapted to convert a ring-shaped spout of the ring-shaped space H in a distal (lower) end of the plasma generation nozzle 31, to a lengthwise spout. The adapter 38 generally comprises an attaching portion 381 fitted on the lower body portion 33B of the nozzle body 33, a plasma chamber body 382 extending horizontally from a lower end of the attaching portion 381, and a pair of slit plates 383, 384 coveringly attached to the plasma chamber body 382.

The attaching portion 381 and the plasma chamber body 382 are integrally formed by machining or casting. The slit plates 383, 384 are formed by machining or punching. In each of the plasma generation nozzle 31, a region of the lower body portion 33B on the side of the lower edge 331 is formed as a reduced-diameter body portion 33B1 which is fittable into the attaching portion 381. This reduced-diameter body portion 33B1 having a thin wall is fitted into the attaching portion 381 to facilitate efficient heat conduction from the nozzle body 33 to the adapter 38.

The attaching portion 381 is formed in a tubular shape capable of receiving therein the reduced-diameter body portion 33B1. When the reduced-diameter body portion 33B1 is fitted into the tubular-shaped attaching portion 381, and then an attaching screw 385 is screwed into a threaded screw hole 3811 formed in a side wall of the attaching portion 381, a distal end 3851 of the attaching screw 385 is fitted into a depression 33B2 formed in an outer peripheral surface of the reduced-diameter body portion 33B1 to prevent the adapter 38 from dropping off the lower body portion 34B. The slit plates 383, 384 are attached to a bottom surface of the plasma chamber body 382 by a plurality of countersunk screws 386.

The plasma chamber body 382 comprises a pair of chamber body portions 3821, 3822 extending horizontally from a lower end 3812 of the attaching portion 381 in opposite directions, and internally defines a lengthwise plasma chamber in gas communication with the ring-shaped space H between the center conductive member 32 and the nozzle body 33. Specifically, the bottom surface of the plasma chamber body 382 is formed with an upwardly-concaved lengthwise concave groove 3823 continuously extending over the chamber body portions 3821, 3822, and an approximately central region of the concave groove 3823 is formed as a large-diameter opening 3824 continuous with an inner peripheral surface of the attaching portion 381.

The slit plates 383, 384 are attached to the bottom surface of the plasma chamber body 382 in such a manner as to cover the concave groove 3823 formed in the bottom surface. Thus, a space surrounded by the slit plates 383, 384 and the chamber body portions 3821, 3822 is defined as a plasma chamber. Further, the slit plates 383, 384 defining one side surface of the plasma chamber are formed to define therebetween an opening serving as a lengthwise spout 387. A plasmatized gas emitted from the columnar space 332 (or ring-shaped space H) of the nozzle body 33 is introduced from the attaching portion 381 to the concave groove 3823 through the opening 3824, and emitted from the spout 387 defined between the slit plates 383, 384, in the form of a line-shaped plume. The spout 387 has a width W0 which is sufficiently larger than that of a diameter φ of the columnar space 332.of the nozzle body 33. For example, when the diameter φ of the columnar space 332 is set at 5 mm, the width W0 of the spout 387 may be set at 70 mm.

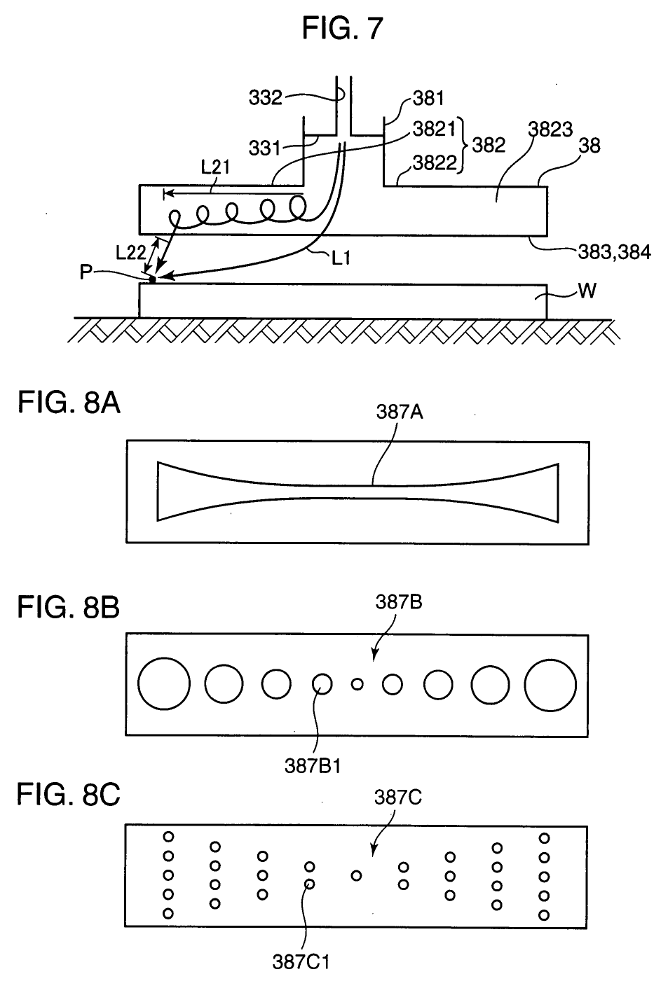

As shown in FIG. 7, if a plasmatized gas is emitted from the ring-shaped space H between the center conductive member 32 and the nozzle body 33, toward a desired exposure position P of a large-surface area workpiece, using the plasma generation nozzle 31 without attaching the adapter 38 thereto, the plasma is highly likely to be cooled and mostly vanished in a path L1 from the ring-shaped space H.

By contrast, in the plasma generation nozzle 31 with the adapter 38 adapted to convert the ring-shaped spout of the ring-shaped space H to the lengthwise spout 387, a path L21 defined in the adapter 38 to be heated to a high temperature can suppress cooling of plasma even when the path L21 and the path L1 have the same length to the exposure position P. In this case, the plasma is cooled only in a short path L22, i.e., during a course after being emitted from an opening position just proximal to the exposure position P through until actually reaching the exposure position P. Thus, even if the exposure position P is located far from the nozzle body 33, plasma becomes less likely to be vanished. This makes it possible to allow a large-surface area workpiece to be evenly exposed to plasma, even using a low-cost, easily-controlled, small-diameter plasma generation nozzle, without using an excessively large plasma generation nozzle.

As also illustrated in FIGS. 5 and 6, the lengthwise spout 387 of the adapter 38 is formed to have an opening area which increases stepwise in an outward direction from a longitudinal center thereof. In the example illustrated in FIGS. 5 and 6, the spout 387 is formed such that a portion 3871 thereof located just below the opening 3824 to directly receive a plasma flow from the ring-shaped space H, has a relatively narrow width W1, for example, of 0.3 mm, and the remaining portion 3872 has a relatively wide width W2, for example, of 0.5 mm.

As the configuration of the spout 387, various types other than the above configuration may be employed. As several examples, FIG. 8A shows a spout 387A having an opening width which continuously increases in the outward direction. FIG. 8B shows a spout 387B comprising a plurality of circular openings 387B1 arranged in a longitudinal direction of an adapter at certain intervals, wherein the circular openings 387B1 are formed to have respective diameters which gradually increase in the outward direction. Further, FIG. 8C shows a spout 387C comprising a plurality of circular openings 387C1 each having the same diameter, wherein the plurality of circular openings 387C1 are divided into plural groups arranged in a longitudinal direction of an adapter at certain intervals, and the number of the circular openings in the respective groups gradually increases in the outward direction. That is, the spout 387 may be formed to have an opening area which increases stepwise or continuously in the outward direction from the longitudinal center thereof.

When the spout 387 is formed in a lengthwise shape, a stream [an emitting pressure, i.e., a flow rate (flow volume per unit time)] of plasma directing outwardly is apt to be deteriorated, and a temperature of the plasma is also apt to be lowered. Thus, instead of simply forming the lengthwise spout 387 to have a constant width, the lengthwise spout 387 is formed to have an opening area increasing stepwise or continuously, as described above, so as to increase an amount of plasma to be emitted, toward an outward side of the lengthwise spout 387. This makes it possible to allow a large-surface area workpiece W to be further evenly exposed to plasma.

The slit plates 383, 384 may be integrally formed as a single piece. Further, while each of the slit plates 383, 384 in the first embodiment has a rectangular side surface formed with a step (i.e., protrusion) for defining the portions 3871, 3872, the step may be formed on a side surface of only one of the slit plates 383, 384, and the other slit plate may have a flat side surface.

In the first embodiment, the plurality of plasma generation nozzles 31 are provided with the adapters 38, respectively, i.e., in a one-to-one correspondence manner. If two or more of the plasma generation nozzles are attached to one adapter 38 having the spout 387, a region having a low plasma density is likely to occur due to collision between respective plasma flows from the adjacent plasma generation nozzles. The first embodiment can avoid such a problem.

The arrangement where one adapter is attached to two or more of the plasma generation nozzles has an advantage, particularly, in terms of an adapter attaching/detaching operation, for example, an advantage of being able to eliminate the need for adjusting an angular position of the adapter about an axis of the plasma generation nozzle. Thus, in cases where two or more plasma generation nozzles are arranged within the lengthwise spout 387 (the opening defined by the slit plates 383, 384), the plasma chamber in the chamber body portions 3821, 3822 may be partitioned by a defector plate (or flow control plate). If the above collision between respective plasma flows from the adjacent plasma generation nozzles can be suppressed by such measures, two or more plasma generation nozzles may be attached to one adapter.

In the first embodiment, the carrying mechanism C is combined with the plasma generation unit PU to form the workpiece processing apparatus S. 1n the workpiece processing apparatus S, a microwave is propagated from the microwave generation device 20 to the plurality of plasma generation nozzles 31 through the waveguide 10, and the plurality of plasma generation nozzles 31 are attached to the waveguide 10 in the form of an array arranged in a longitudinal direction D2 of the waveguide 10 which is orthogonal to a carrying direction D1 of a workpiece W.

In this workpiece processing apparatus S, as enlargedly shown in FIG. 6, the adapter 38 is preferably attached to each of the plasma generation nozzles 31 in such a manner as to an axis D3 of the adapter 38, i.e., a longitudinal axis of the spout 387, is inclined by a predetermined offset angle a with respect to a direction of the array of plasma generation nozzles 31 (i.e., the longitudinal direction of the waveguide 10).

This arrangement can further reliably prevent plasmas emitted from respective longitudinal ends of the lengthwise spouts 387 of the adjacent adapters 38 from colliding with each other. This makes it possible to suppress lowering in plasma density around the end of the spout 387.

More preferably, the adjacent adapters 38 are positioned to allow the respective longitudinal ends of the spouts 387 thereof to overlap each other when viewed from the carrying direction D1. The carrying direction D1 means a direction orthogonal to a direction of the array of plasma generation nozzles 31 in a plane defined by the array of plasma generation nozzles 31. This arrangement makes it possible to provide an approximately uniformed density to plasmas to be emitted from vicinities of the respective longitudinal ends of the lengthwise spouts 387 toward a workpiece W at a relatively low density. An overlap value W4 may be appropriately determined depending on a length of the chamber body portions 3821, 3822, a configuration of the spout 387, a flow rate of the processing gas and others.

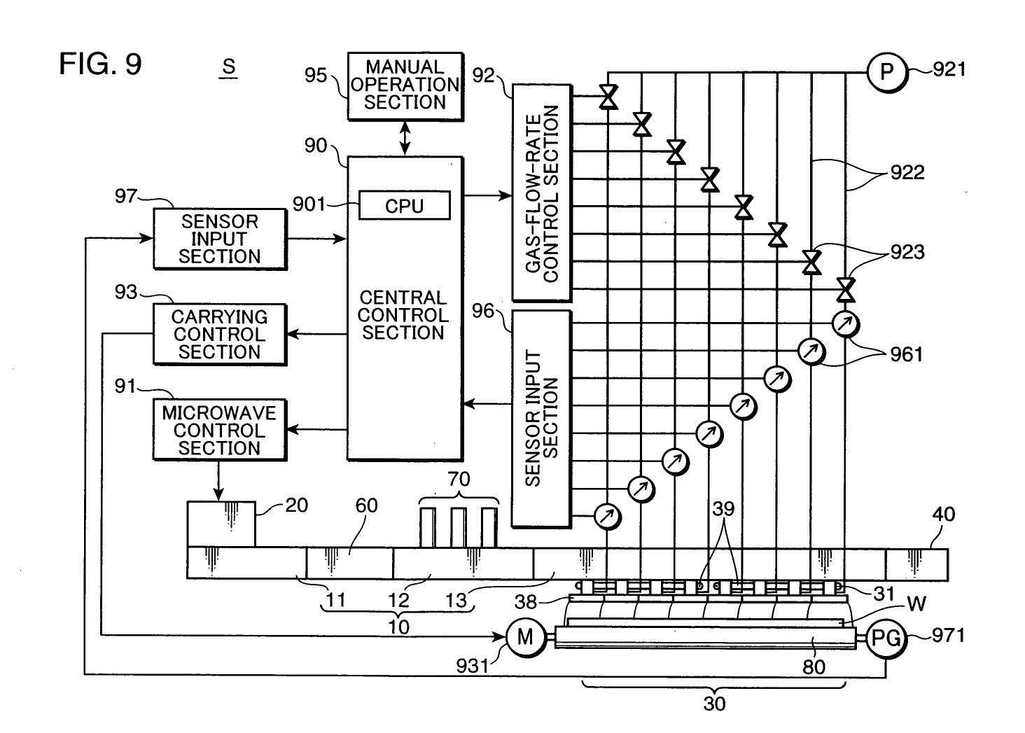

An electric configuration of the workpiece processing apparatus S according to the first embodiment will be described below. FIG. 9 is a block diagram showing a control system of the workpiece processing apparatus S. This control system comprises: a central control section 90 including a CPU (Central Processing Unit) 901 and a peripheral circuit; a microwave control section 91 including an output interface and a drive circuit; a gas-flow-rate control section 92; a carrying control section 93; a manual operation section 95 including a display unit and an operation panel and serving as a means to give a predetermined operating signal to the central control section 90; first and second sensor input sections 96, 97 each including an input interface and an analog/digital converter; a plurality of flow-rate sensors 961; a speed sensor 971; a drive motor 931; and a plurality of flow-rate control valves 923.

The microwave control section 91 is provided as a means to control on/off and an output intensity of a microwave to be output from the microwave generation device 20. The microwave control section 91 is operable to generate the pulse signal of 2.45 GHz in such a manner as to control the microwave generation operation in the device body section 21 of the microwave generation device 20.

The gas-flow-rate control section 92 is provided as a means to control a flow rate of processing gas to be supplied to each of the plasma generation nozzles 31 in the plasma generation section 30. Specifically, the gas-flow-rate control section 92 is operable to control open/close and an opening degree of each of the flow-rate control valves 923 provided in respective gas supply pipes 922 connecting between a processing-gas supply source 921, such as a compressed gas cylinder, and the plasma generation nozzles 31.

The carrying control section 93 is provided as a means to control an operation of the drive motor 931 for rotationally driving the carrier rollers 80. The carrying control section 93 is operable to control start/stop of the carrying and a carrying speed of a workpiece W.

The central control section 90 is provided as a means to govern an overall operation of the workpiece processing apparatus S. The central control section 90 is operable, in response to an operating signal given from the manual operation section 95, to control respective operations of the microwave control section 91, the gas-flow-rate control section 92 and the carrying control section 93 according to a predetermined sequence, while monitoring a measurement result about processing gas flow rate detected by each of the flow-rate sensors 961 and input from the first sensor input section 96, a measurement result about the carrying speed of the workpiece W detected by the speed sensor 971 and input from the second sensor input section 97, and others.

Specifically, the CPU 901 is operable, based on a control program pre-stored in a memory, to instruct the carrying control section 93 to start carrying a series of workpieces W so as to carry a leading one of the workpieces W to the plasma generation section 30, and instruct the microwave control section 91 to give a microwave power to the plasma generation section 30 while monitoring the measurement result of each of the flow-rate sensors 961 to instruct the gas-flow-rate control section 92 to supply a predetermined flow rate of processing gas to the plasma generation section 30, so as to generate a plasmatized processing gas and emit the plasmatized processing gas to a surface of the leading workpiece W. In this manner, a plurality of workpieces W can be continuously subjected to the plasma processing.

In the workpiece processing apparatus S according to the first embodiment, a plasmatized gas can be emitted toward a workpiece W from the adapters 38 attached to the respective distal ends of the array of plasma generation nozzles 31 mounted to the waveguide 10, while carrying a series of workpieces W by the workpiece carrying mechanism C. Thus, a plurality of workpieces can be continuously subjected to a plasma processing, and a large-surface area workpiece can also be efficiently subjected to a plasma processing. This makes it possible to provide a workpiece processing apparatus S or a plasma generation apparatus (plasma generation unit) PU having excellent plasma processing efficiency as compared with a batch-type workpiece processing apparatus. In addition, the plasma generation apparatus can generate plasma under ambient temperatures and atmospheric pressures, so that the need for a vacuum chamber or the like can be eliminated to simplify the structure of processing equipment.

In the workpiece processing apparatus S according to the first embodiment, a microwave generated from the microwave generation device 20 is received by the receiving antenna portion 320 provided in each of the plasma generation nozzles 31, and a plasmatized gas generated based on the received microwave energy is emitted from each of the plasma generation nozzles 31. Thus, a mechanism for transmitting microwave energy to each of the plasma generation nozzles 31 can be simplified. This makes it possible to facilitate structural simplification and cost reduction of the apparatus.

In the workpiece processing apparatus S according to the first embodiment, the plasma generation section 30 comprising the plurality of plasma generation nozzles 31 arranged in an array has a width approximately equal to a lateral size t (i.e., a size in a direction orthogonal to a carrying direction) of a flat plate-shaped workpiece W. Thus, an entire surface of the workpiece W can be subjected to a plasma processing by allowing the workpiece W to pass through the plasma generation section 30 only once, using the carrying mechanism C. This makes it possible to drastically improve efficiency of a plasma processing for a flat plate-shaped workpiece.

In the workpiece processing apparatus S according to the first embodiment, the cooling pipe line 39 is arranged to come into contact with the nozzle holder 34. Thus, an enhanced cooling function can be obtained as compared with air-cooling using a fan or the like. This makes it possible to prevent loosing of the center conductive member 32 due to thermal degradation of the sealing member 35, so as to ensure stable plasma ignition, and prevent the occurrence of an undesirable situation where heat is conducted from the plasma generation nozzles 31 to the waveguide 10 in a low-temperature environment to cause dew condensation. While the air-cooling using a fan or the like is likely to raise a plume of dust, the above cooling structure can avoid such a problem.

### Modifications of First Embodiment

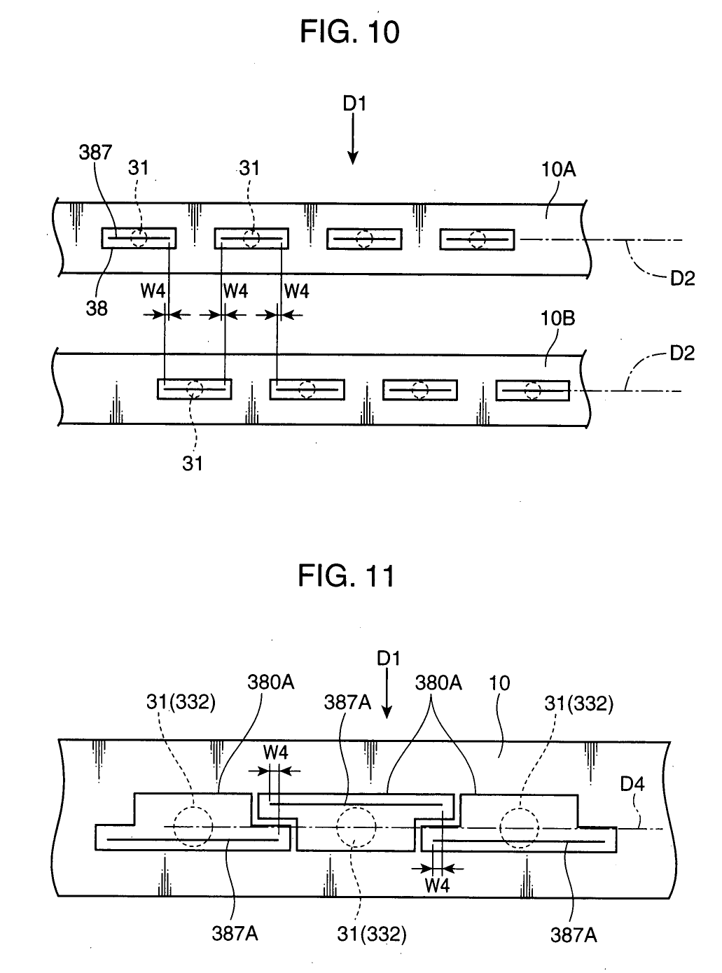

FIG. 10 is an explanatory diagram showing an arrangement of the plasma generation nozzles 31 with the adapters 38, in one example of modification of the workpiece processing apparatus according to the first embodiment. FIG. 10 is a bottom plan view of the plasma generation section 30.

In the example illustrated in FIG. 10, the waveguide 10 is formed as two waveguides 10A, 10B which are disposed in spaced-apart relation to each other in the carrying direction D1 of a workpiece W, and each of which is disposed to extend in a direction (D2) orthogonal to the carrying direction D1. The plurality of plasma generation nozzles 31 are grouped into two arrays each mounted to a corresponding one of the waveguides 10A, 10B in such a manner that the plasma generation nozzles 31 in each of the arrays are disposed in spaced-apart relation to each other, i.e., at even intervals, in a longitudinal direction D2 of the waveguide. Further, the respective arrays of plasma generation nozzles 31 are disposed in displaced relation to each other when viewed from a direction (the carrying direction D1) orthogonal to a direction of each of the arrays, in a plane defined by the arrays. That is, the plurality of plasma generation nozzles 31 are disposed in a zigzag pattern in bottom plan view. Further, the adapters 38 is provided to each of the plasma generation nozzles 31, in such a manner that the lengthwise spout 387 has a longitudinal axis positioned approximately parallel to the array direction, i.e., the longitudinal direction D2.

This arrangement also makes it possible to prevent plasmas emitted from respective longitudinal ends of the lengthwise spouts 387 of the adjacent adapters 38 from colliding with each other, so as to suppress lowering in plasma density around the end of the spout 387.

Further, adjacent ones of the adapters 38 are positioned to allow respective longitudinal ends of the lengthwise spouts 387 of the adjacent adapters 38 to overlap each other, when viewed from the carrying direction D1. This arrangement makes it possible to provide an approximately uniformed density to plasmas to be emitted from vicinities of the respective longitudinal ends of the lengthwise spouts 387 toward a workpiece W at a relatively low density. In this example, the plurality of plasma generation nozzles 31 are grouped into two arrays which are disposed in spaced-apart relation to each other in the carrying direction D1 and each of which extends in the direction (D2) orthogonal to the carrying direction D1. That is, for example, plural arrays of plasma generation nozzles 31 may be arranged in a single waveguide 10.

FIG. 11 is an explanatory diagram showing an arrangement of the plasma generation nozzles 31 with the adaptors 380A, in another example of modification of the workpiece processing apparatus according to the first embodiment. FIG. 11 is also a bottom plan view of the plasma generation section 30.

In this example of modification, the plurality of plasma generation nozzles 31 are mounted to the waveguide 10 extending a direction (D4) orthogonal to the carrying direction D1, in such a manner as to be disposed on a single straight line D4 along the longitudinal direction. A plurality of adapters 380A are attached to corresponding ones of the plasma generation nozzles 31, in such a manner that respective lengthwise spouts 387A of the adapters 380A are positioned parallel to a longitudinal axis of the waveguide 10 and alternately offset in the carrying direction D1.

In the example illustrated in FIG. 11, each of the adapters 380A is formed with a lengthwise spout 387A offset from a center (located on the D4) of the ring-shaped spout (the ring-shaped space H), and the adapters 380A are attached to respective ones of the plasma generation nozzles 31 in such a manner as to be alternately rotated by 180 degrees.

Thus, even if the plasma generation nozzles 31 are disposed on the single straight line D4, the above arrangement makes it possible to prevent plasmas emitted from respective longitudinal ends of the lengthwise spouts 387A of the adjacent adapters 380A from colliding with each other so as to suppress lowering in plasma density around the end of the spout 387, by use of the common adapters 380A. In this offset arrangement, the aforementioned overlap may additionally set to provide an approximately uniformed density to plasmas to be emitted from vicinities of the respective longitudinal ends toward a workpiece W.

### Second Embodiment

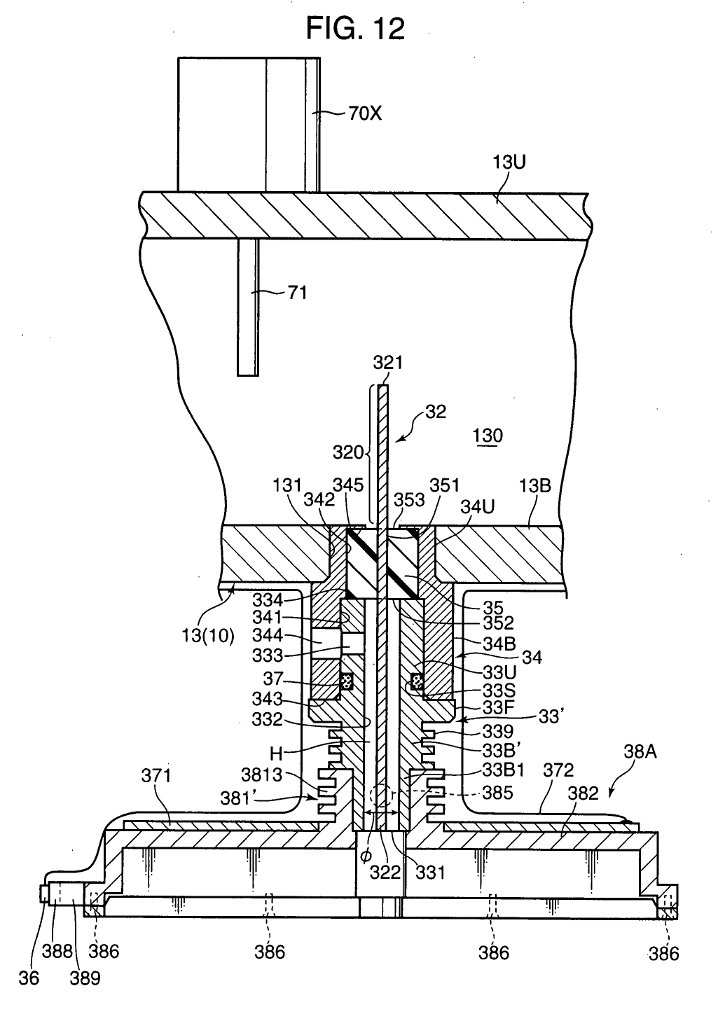

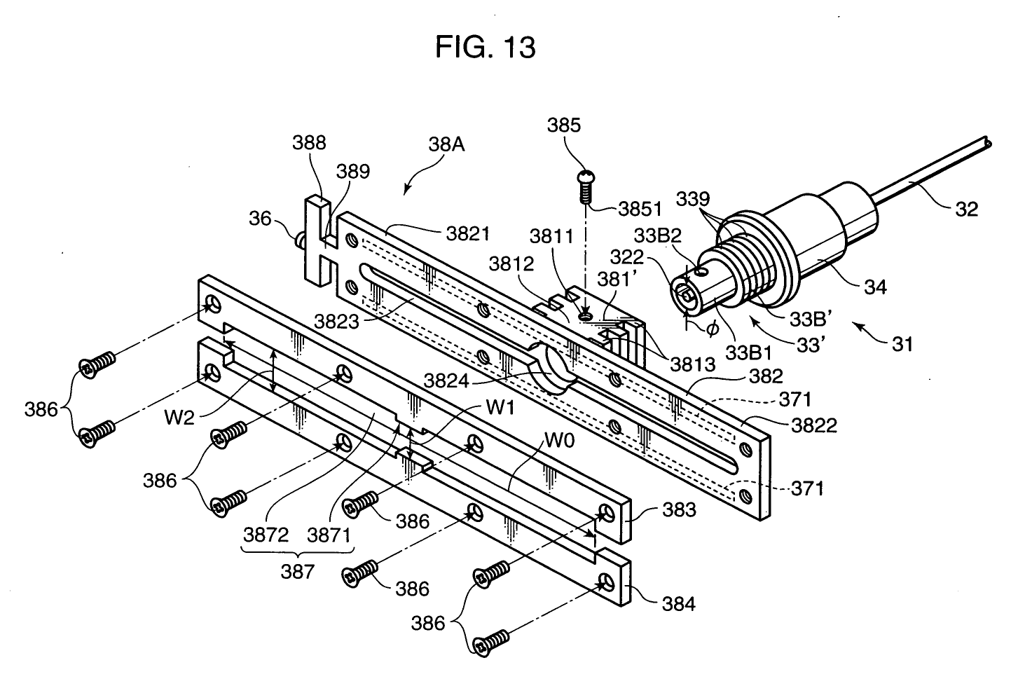

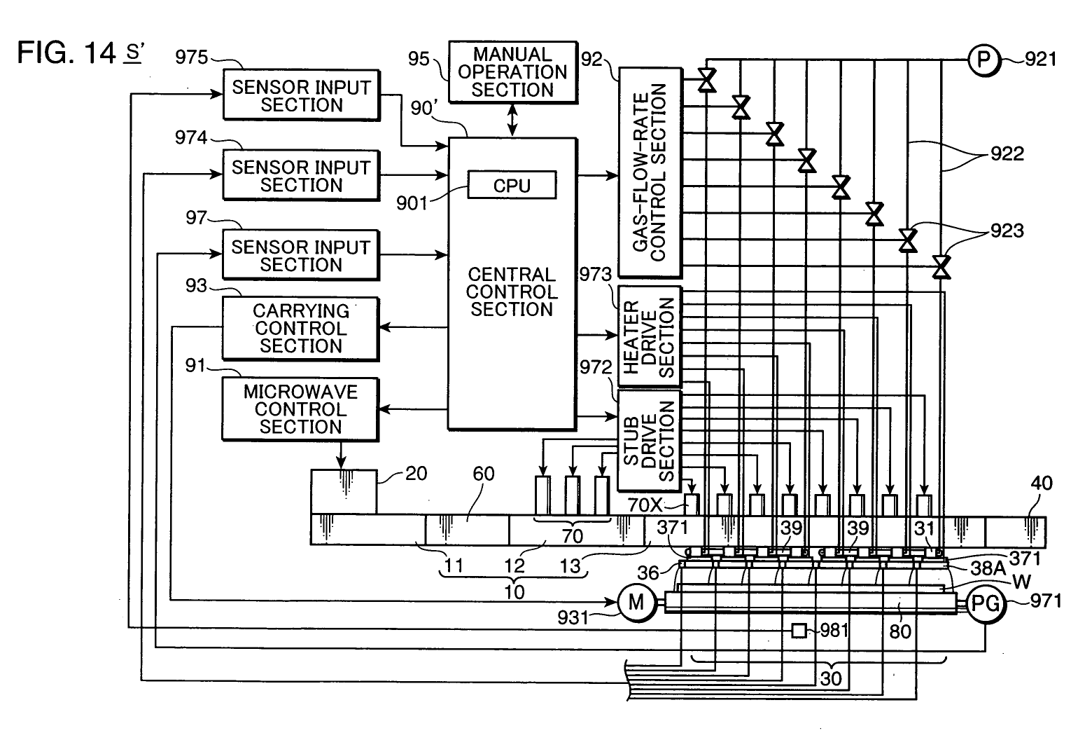

FIG. 12 is an enlarged sectional view showing a mounting portion of a waveguide for a plasma generation nozzle 31 with an adapter 38A, in a workpiece processing apparatus according to a second embodiment of the present invention. FIG. 13 is an exploded perspective view showing the adapter 38A.

Each of the plasma generation nozzle 31 and the adapter 38A has fundamentally the same structure as that in the first embodiment illustrated in FIG. 4. Thus, the same element or component is defined by the same reference numeral or code, and its description will be simplified or omitted. The second embodiment is different from the first embodiment in that: heat-radiation fins 339, 3813 are provided in a connection portion between the plasma generation nozzle 31 and the adapter 38A; a temperature sensor 36 (temperature detection element) adapted to detect a temperature of the adapter 38A is attached to the adapter 38A; a heater 371 adapted to pre-heat the adapter 38A is attached to the adapter 38A; and a plurality of stub tuner units 70X are provided to the plasma generation nozzles 31 in a one-to-one correspondence manner. The following description will be made about these differences.

In the second embodiment, a lower body portion 33B′ of a nozzle body 33′ in the plasma generation nozzle 31 is provided with a heat-radiation fin 339 protruding outwardly from an outer peripheral surface thereof. Further, an attaching portion 381′ of the adapter 38A is provided with a heat-radiation fin 3813 protruding outwardly from an outer peripheral surface thereof.

When the adapter 38A stores plasma gas therein, it will be heated to a high temperature. It is desired to minimize propagation of this heat toward the plasma generation nozzle 31. For this purpose, the heat-radiation fin 339, 3813 are provided on the respective outer peripheral surfaces of the lower body portion 33B′ and the attaching portion 381′ to dissipate the heat. In combination with a cooling effect of a cooling pipe line 39 (see FIGS. 1 to 3), the heat-radiation fin 339, 3813 can prevent the waveguide 10 from being heated to a high temperature, and avoid a problem caused by excessively high temperature of the plasma generation nozzle 31, such as heat degradation of a sealing member 35.

A temperature sensor 36 is attached to one end of the adapter 38A. The adapter 38A is grounded through the nozzle body 33′ and the nozzle holder 34, and therefore electrically kept at a ground level. Thus, the adapter 38A is applied with no energy, and not heated when plasma is not generated. In contrast, when plasma is ignited, a plasma chamber in a plasma chamber body 382 is filled with high-temperature plasma, and a temperature of the adapter 38A is increased in proportion to energy consumed by the plasma generation nozzle 31 if the adapter 38 has a low heat capacity, for example, because it is formed as a thin-walled member.

From this point of view, the temperature sensor 36 is attached to the adapter 38A to measure the temperature of the adapter 38A so as to estimate the consumed energy. Thus, even if the adapter 38A is attached to the plasma generation nozzle 31, i.e., a distal end of the plasma generation nozzle 31 cannot be visually checked directly, the temperature sensor 36 makes it possible to estimate whether or not plasma is ignited, and a temperature of plasma when it is ignited. Then, an amount of processing gas to be supplied to each of the plasma generation nozzles 31 can be controlled based on the detection result of the temperature sensor 36 to adjust the state of plasma ignition.

In this embodiment, the temperature sensor 36 is attached to a mounting portion 388 provided at one end of the plasma chamber body 382. This mounting portion 388 is formed at an end of a thin-walled portion 389 extending from an end of the adapter 38A. That is, the temperature sensor 36 is not attached directly to the adapter 38A which is to be heated to a high temperature when it stores plasma gas therein as mentioned above, but to the adapter 38A through the thin-walled portion 389. This makes it possible to protect the temperature sensor 36 from excessive heat conduction without adverse effects on the temperature detection.

For example, a thermistor, a thermocouple or an infrared radiation sensor may be used as the temperature sensor 36. The temperature sensor 36 is attached to the mounting portion 388 by bonding or screwing. Alternatively, a mounting hole is formed in the mounting portion, and the temperature sensor 36 is fitted into the mounting hole. If the temperature sensor 36 has a heat resistance, the temperature sensor 36 may be installed in any surface of the plasma chamber body 382 or within the plasma chamber body 382.

The adapter 38A is further provided with a heater 371 adapted to pre-heat the adapter 38A. This heater 371 is formed of a heat element or a wire heater, and adapted to generate heat in response to voltage applied between lead wires led from opposite ends of the heat element or the wire heater.

After the plasma generation nozzle 31 is operated for a minute (e.g., about 5 minutes), the adapter 38A is heated to a high temperature by plasma gas stored therein as mentioned above, and, even if plasma is quenched, a microwave can be applied thereto to readily achieve re-ignition. However, when the adapter 38A is cooled, for example, in case where the plasma generation nozzle 31 is initially activated or re-operated after stop for a while, plasma ignition in the plasma generation nozzle 31 with the adapter 38A becomes harder than that in the plasma generation nozzle 31 devoid of the adapter 38A. Thus, with a view to improving activation performance, the heater 371 is added to the adapter 38A. This makes it possible to readily achieve plasma ignition without detaching the adapter 38A, and uniformly emit plasma immediately after plasma ignition. This function is desirable, particularly, for a workpiece processing apparatus in which workpieces are intermittently carried in, and thereby it is required to frequently repeat ignition/quenching of plasma.

In this embodiment, the state of plasma ignition is controlled using a plurality of stub tuner units 70X provided to the plasma generation nozzles 31 in a one-to-one correspondence manner. Each of the stub tuner units 70X is adapted to adjust a protruding length of a stub 71 relative to a waveguide space 130. Specifically, the protruding length can be increased to reduce energy to be consumed by a corresponding one of the plasma generation nozzles 31;

The stub tuner units 70X can be used for controlling a microwave power to be given to each of the plasma generation nozzles 31 so as to facilitate adjusting the plasma ignition/quench and a temperature of plasma at ignition. Particularly, in the waveguide 10 provided with a plurality of plasma generation nozzles 31, the stub tuner units 70X can be provided to the plasma generation nozzles 31 in a one-to-one correspondence manner so as to facilitate adjusting the plasma ignition/quench and a temperature of plasma at ignition.

Each of the stub tuner units 70X has the same structure as that of the aforementioned the stub tuner units 70A to 70C. The stub tuner unit 70X is designed to adjust the protruding length of the stub 71 using a step motor or the like. The stepping motor may be provided in each of the stub tuner units 70A to 70C and 70X. Alternatively, the stepping motor may be provided as a common element, and a transmission device, such as a gear mechanism, may be additionally used for adjusting the individual protruding lengths of the stub tuner units 70X.

An electric configuration of a workpiece processing apparatus S′ according to the second embodiment will be described below. FIG. 14 is a block diagram showing a control system of the workpiece processing apparatus S′. In FIG. 14, the same element or component as that in the first embodiment described based on FIG. 9 is defined by the same reference numeral or code.

This control system comprises: a central control section 90′ including a CPU 901; a microwave control section 91; a gas-flow-rate control section 92; a carrying control section 93; a stub drive section 972; a heater drive section 973; a manual operation section 95; second, third and fourth sensor input sections 97, 974, 975 each including an input interface and an analog/digital converter; a plurality of temperature sensors 36; a speed sensor 971; a workpiece detection sensor 981; a drive motor 931; a plurality of flow-rate control valves 923; the stub tuner units 70A to 70C and 70X; and the heater 371.

Each of the microwave control section 91, the gas-flow-rate control section 92 and the carrying control section 93 has the same function as that in the first embodiment. The stub drive section 972 is operable to control driving of the stub tuner units 70A to 70C and 70X. The heater drive section 973 is operable to control driving of the heater 371.

Each of the temperature sensors 36 is operable to measure a temperature of a corresponding one of the adapters 38A, as described above. The speed sensor 971 is operable to detect a carrying speed of a workpiece W. The workpiece detection sensor 981 is disposed in a carrying path of the workpiece W, and operable to detect a carrying position of the workpiece W based on whether a light path between the light-emitting element (not shown) and the workpiece detection sensor 981 is cut off (including reduction in amount of transmitted light, when the workpiece is a light-transparent material, such as glass substrate) or formed (whether there is a reflected light from the workpiece W). An output of the speed sensor 971, outputs of the temperature sensors 36 and an output of the workpiece detection sensor 981 are sent to the second sensor input section 97, the third sensor input section 974 and the fourth sensor input section 975, respectively.

The central control section 90′ is provided as a means to govern an overall operation of the workpiece processing apparatus S′. The central control section 90′ is operable, in response to an operating signal given from the manual operation section 95, to control respective operations of the microwave control section 91, the gas-flow-rate control section 92, the carrying control section 93, the stub drive section 972 and the heater drive section 973 according to a predetermined sequence, while monitoring, a measurement result about the carrying speed of the workpiece W detected by the speed sensor 971 and input from the second sensor input section 97, a measurement result about a temperature of each of the adapters 38A detected by each of the temperature sensors 36 and input from third sensor input section 974, and a carrying position of the workpiece W detected by the workpiece detection sensor 981 and input from the fourth sensor input section 975.

Specifically, the CPU 901 is operable, in response to an instruction of starting a plasma processing, to start an operation of the workpiece processing apparatus S′. Then, the CPU 901 is operable, based on a control program pre-stored in a memory, to instruct the carrying control section 93 to activate the drive motor 931 so as to start carrying a workpiece W to the plasma generation section 30. The CPU 901 is operable to read the carrying speed of the workpiece W from the speed sensor 971 through the second sensor input section 97 so as to adjust the carrying speed at a constant value.

In conjunction with the start of carrying of the workpiece W, or when the workpiece W reaches a predetermined position, the CPC 901 is operable to instruct the heater drive section 973 to start pre-heating the heaters 371. The CPU is also operable to instruct the gas-flow-rate control section 92 to control the flow-rate control valves 923 so as to supply a predetermined flow rate of processing gas to each of the plasma generation nozzles 31, and instruct the microwave control section 91 to allow the microwave generation device 20 to generate a microwave power greater than that in a steady glow state so as to heat each of the plasma generation nozzles 31.

In this state, the CPU 901 is operable to instruct the stub drive section 972 to retract (fully open) the stub 71 in each of the stub tuner units 70X corresponding to the respective the plasma generation nozzles 31, and scanningly drive the stub tuner units 70A, 70B, 70C so as to change a standing wave pattern in the waveguide 10. Through this operation, each of the plasma generation nozzles 31 performs plasma ignition. Then, it is checked whether or not a temperature of each of the adapters 38A reaches a predetermined value or more, according to the measurement result of each of the temperature sensors 36, so as to determine whether or not plasma is ignited. A current supply to the heaters 371 is terminated when the measurement result about the temperature of each of the adapters 38A detected by the temperature sensors 36 and input from the third sensor input sections 974 reaches a predetermined value according to the plasma ignition.

When the plasma ignition in all the plasma generation nozzles 31 is detected, the CPU 901 is operable to instruct the microwave control section 91 to lower the microwave power to a level in the steady glow state, instruct the stub drive section 972 and the gas-flow-rate control section 92 to control the stub tuner units 70X and the flow-rate control valves 923 in such a manner that each of the adapters 38A has the same temperature. The carrying speed is controlled to allow the workpiece W to pass through the plasma generation section 30 when each of the adapters 38A has the same temperature to allow plasma to be evenly emitted therefrom. Further, the CPU 901 is operable to inform an operator of a ready state for plasma exposure, by lighting of a lamp in the manual operation section 95.

A trailing end of the workpiece W is detected by the workpiece detection sensor 981 and the detected result is input through the fourth sensor input section 975 to the CPU 901. If the next workpiece W is not detected, the CPU 901 is operable to stop supply of the processing gas and generation of the microwave when the trailing end passes through the plasma generation section 30 or after an elapse of a predetermined time from the passage.

Further, at the above timing or in response to detecting that the temperature of each of the adapters 38A is lowered to a predetermined temperature, the CPU 901 is operable to instruct the heater drive section 973 to drive the heaters 371. The drive motor 931 is also stopped at an appropriate timing after the last workpiece W is taken away from the workpiece processing apparatus S′. Depending on the carrying speed of the workpiece W and the installation position of the workpiece detection sensor 981, the plasma ignition may be performed in response to detecting a leading end of a workpiece W.

The plasma ignition is not always achieved even if the plasma generation nozzle 31 is operated under the same conditions every time, but occurs fortuitously. Thus, when the plasma ignition is not achieved in all the plasma generation nozzles 31 even if a predetermined time has elapsed after the stub tuner units 70A, 70B, 70C were scanningly driven, the CPU 901 is operable to instruct the microwave control section 91 to perform a re-start (reset) operation of stopping generation of a microwave and then restarting the generation of the microwave.

When the temperature sensors 36 detect that the temperature of at least one of the adapters 38A has an abnormal value, it is determined that the plasma generation nozzle 31 of the adapter 38A does not have a glow discharge but an arc discharge, and the CPU 901 is operable to instruct the microwave control section 91 to perform a protection operation of stopping the generation of the microwave. This makes it possible to prevent damages of a center conductive member 32 (serving as an inner electrode), the nozzle body 33′ (serving as an outer electrode), and the sealing member 35 supporting the center conductive member 32. The generation of the microwave may be automatically restarted after an elapse of a predetermined time from initiation of the protection operation, or at a time when the detected temperature is lowered to a predetermined value or less. For the purpose of detecting such arcing, a temperature sensor or a light sensor for detecting plasma ignition may be directly attached to each of the plasma generation nozzles 31.

As above, based on the detection result of the workpiece detection sensor 981, at least one of the processing gas supply amount and the microwave power is controlled to control the plasma ignition/quench, and the driving of the heaters 37 is controlled. This makes it possible to uniformly emit plasma gas while suppressing wear of the plasma generation nozzles 31 and consumption of the processing gas.

### Third Embodiment

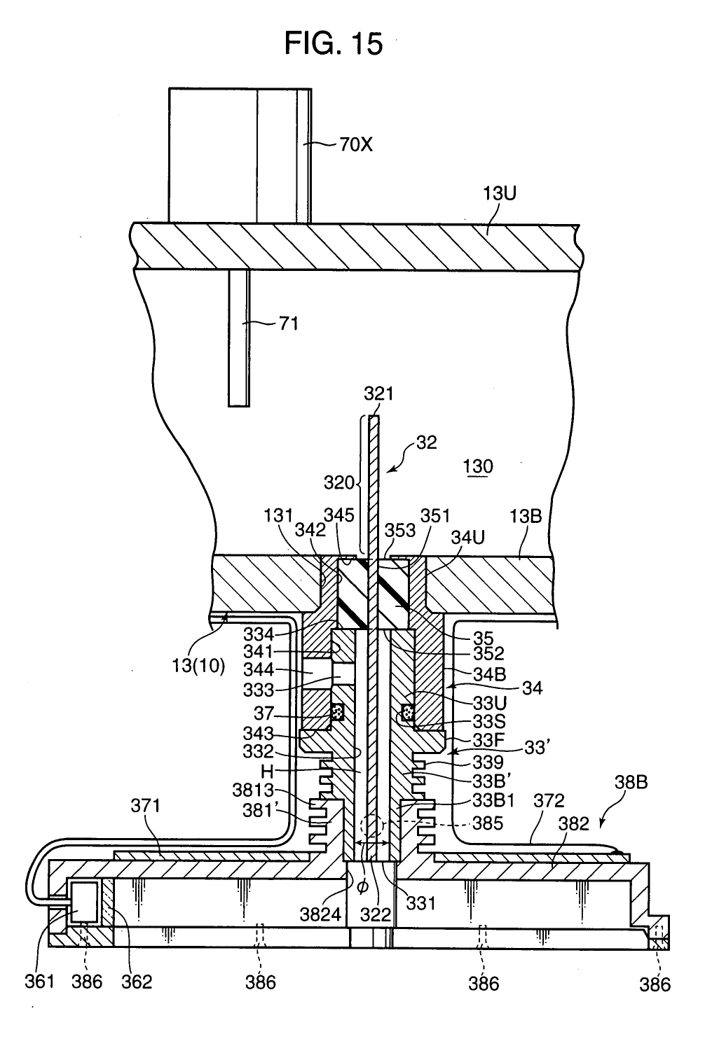

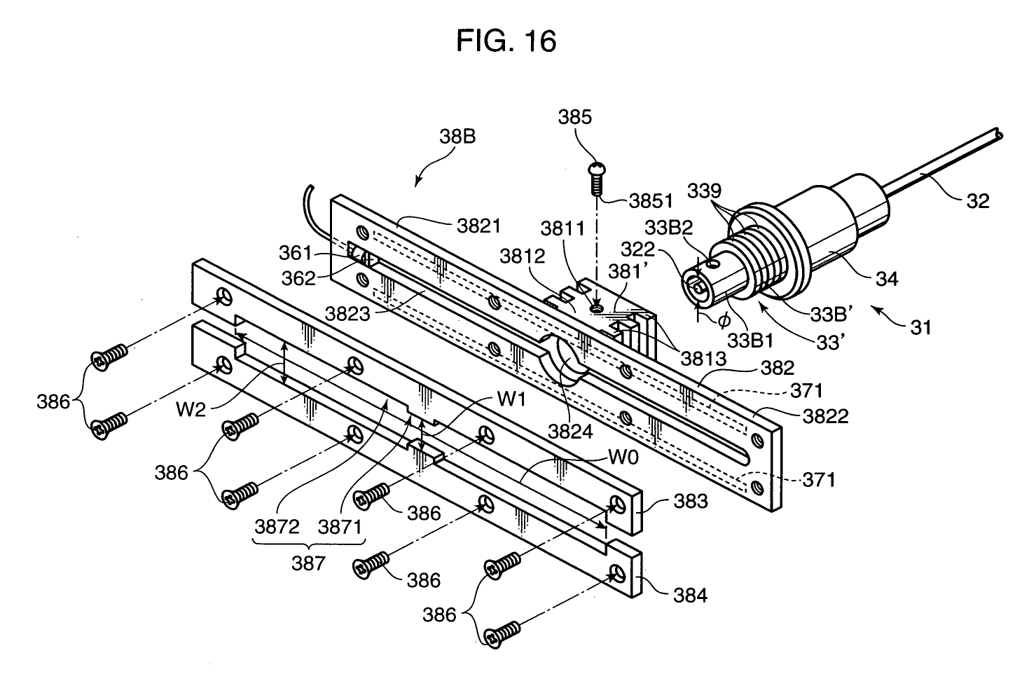

FIG. 15 is an enlarged sectional view showing a mounting portion of a waveguide for a plasma generation nozzle 31 with an adapter 38B, in a workpiece processing apparatus according to a third embodiment of the present invention. FIG. 16 is an exploded perspective view showing the adapter 38B.

Each of the plasma generation nozzle 31 and the adapter 38B has fundamentally the same structure as that in the second embodiment illustrated in FIGS. 12 and 13. Thus, the same element or component is defined by the same reference numeral or code, and its description will be simplified or omitted. The third embodiment is different from the second embodiment in that a light sensor 361 (light detection element) is provided to detect light generated by plasmatized gas within the adapter 38B, in place of the temperature sensor 36.

In the workpiece processing apparatus using the adapter 38B which temporarily confines gas released from the plasma generation nozzle 31, it becomes more difficult to determine whether or not plasma is ignited. From this point of view, in the third embodiment, the adapter 38B is provided with a light sensor 361 adapted to detect plasma emission (plasma light emission) within a plasma chamber body 382.

The light sensor 361 makes it possible to determine whether plasma is ignited, based on a color and luminance of plasma emission, even if a distal end of the plasma generation nozzle 31 cannot be visually checked directly, and estimate a temperature and size of plasma on a color and luminance of plasma emission when ignited. Then, based on the detection result, an amount of processing gas to be supplied to each of the plasma generation nozzles 31 can be adjusted to control a state of plasma ignition. In this control, as with the second embodiment, a plurality of stub tuner units may be provided to the plasma generation nozzles 31 in a one-to-one correspondence manner to control the state of plasma ignition.

The light sensor 361 is installed at one end of the plasma chamber body 382. The light sensor 361 is not installed in such a manner as to be exposed to an internal space of the plasma chamber body 382 storing a high-temperature plasma gas, but in a space which is a part of the internal space separated from the remaining space by a shielding member 362 made of a material having heat resistance and light translucency, such as glass. This makes it possible to maintain a temperature of the light sensor 361 at an allowable value, for example, about 70° C., without causing deterioration in modification function due to lowering of a temperature of plasma, and suppress adverse effect of excessive high temperature, such as change in sensitivity and increase in dark current of the light sensor 361.

It is not essential to position the light sensor 361 at the end of the internal space of the plasma chamber body 382. When the light sensor 361 has heat resistance, and the plasma chamber body 382 has an inner surface formed, for example, by machining, plating or coating, to have a high reflectance, the light sensor 361 may be installed at any position in the internal space of the plasma chamber body 382.

A photoelectric conversion element, such as a photodiode or a phototransistor, may be used as the light sensor 361. Preferably, a plurality of photoelectric conversion elements are arranged in an array, or a single photoelectric conversion element is divided into a plurality of sensing areas, and a wavelength-selective filter adapted to identify a plasma emission color is provided on the array of photoelectric conversion elements or the photoelectric conversion element with the plurality of sensing areas. For example, after forming a mounting hole in the plasma chamber body 382 to extend from one end to the internal space thereof, and the light sensor 361 may be fixedly fitted into the mounting hole.

The attaching structure of the light sensor 361 to the plasma chamber body 382 is not limited to the above type. For example, a thin-walled pipe made of a material having a light shielding property is formed to extend outwardly from one end of the plasma chamber body 382, and a heat-insulating casing made, for example, of Teflon (which is a registered trademark) is provided at a distal end of the pipe. Then, the light sensor 361 may be installed in the casing. This structure can further suppress heat conduction to the light sensor 361.

Alternatively, a mounting hole is formed in one end of the plasma chamber body 382, and a condenser lens having heat resistance is fitted into the mounting hole. Then, one end of fiber optics may be positioned to face the condenser lens to lead plasma emission outside. The light sensor 361 is disposed in opposed relation to the other end of the light sensor 361. This structure makes it possible to prevent the light sensor 361 from being adversely effected by heat of the adapter 38B so as to reliably suppress degradation of the light sensor 361.

A control system of the workpiece processing apparatus according to the third embodiment is substantially the same as that in the second embodiment. That is, the light sensor 361 in the third embodiment has the same roll in a control system as that of the temperature sensor 36 in the second embodiment. Thus, the temperature sensor 36 in the second embodiment may be substituted with the light sensor 361, and the third sensor input section 974 may be used for the light sensor 361. Then, the CPU 901 may be configured to control the gas supply amount to each of the plasma generation nozzles 31 and/or the microwave power, based on a detection result of the light sensor 361.

### Other Modification

While the present invention has been described based the above workpiece processing apparatus S according to specific embodiments thereof, the present invention is not limited to these embodiments. For example, the embodiments may be modified as follows.

(1) In the above embodiments, the carrying mechanism C adapted to carry a workpiece W is used as moving means, and a structure designed to carrying a workpiece W while placing it on top surfaces of the carrier rollers 80 is shown as one example of the carrying mechanism C. Alternatively, the carrying mechanism C may have a structure designed to carry a workpiece W while nipping it between upper and lower carrier rollers, or a structure designed to receive a workpiece W in a predetermined container, such as a basket, and carry the container with the workpiece W by a line conveyer, without using the carrier rollers, or a structure designed to carry a workpiece W to the plasma generation section 30 while holding it by a robot hand or the like. Alternatively, the moving means may include a structure designed to move the plasma generation nozzle 31. Specifically, a workpiece W and the plasma generation nozzles 31 may be relatively moved on a plane (X or Y plane) intersecting a plasma emitting direction (Z direction).

(2) In the above embodiments, the magnetron adapted to generate a microwave of 2.45 GHz is shown as one example of the microwave generation source. Alternatively, any other suitable type of high-frequency power source other than the magnetron may be used, and a microwave having a wavelength different from 2.45 GHz may be used.

### INDUSTRIAL APPLICABILITY

The workpiece processing apparatus and the plasma generation apparatus of the present invention as described based on the first to third embodiments can be suitably applied to an etching system or a film-forming system for a semiconductor substrate, such as semiconductor wafer, a cleaning system for a printed circuit board or a glass substrate, such as plasma display panel, a sterilization system for medical equipment, or a decomposition system for proteins.

The above specific embodiments primarily include an invention having the following features.

A plasma generation apparatus according to a first aspect of the present invention comprises: a microwave generation section adapted to generate a microwave; a gas supply section adapted to supply a gas to be plasmatized; a plasma generation nozzle which includes an inner electrode adapted to receive the microwave, and an outer electrode concentrically disposed outside the inner electrode, wherein the plasma generation nozzle is adapted to plasmatize the gas supplied from the gas supply section thereinto, based on energy of the microwave, and emit the plasmatized gas from a distal end thereof; and an adapter attached to the distal end of the. plasma generation nozzle. In this plasma generation apparatus, the inner and outer electrodes of the plasma generation nozzle are disposed to allow a glow discharge to be induced therebetween so as to plasmatize the gas in a space defined therebetween, and, according to a new supply of the gas into the space, emit the plasmatized gas under atmospheric pressures from a ring-shaped spout of the space in the distal end of the plasma generation nozzle, and the adapter is adapted to convert the ring-shaped spout to a lengthwise spout thereof.

In the plasma generation apparatus of the present invention, the adapter adapted to convert the ring-shaped spout to a lengthwise spout thereof is attached to the distal end of the plasma generation nozzle. In a flow path within the adapter, plasma is less likely to be cooled. Thus, even if a plasma exposure position is located far from the nozzle, a rate of plasma to be vanished can be reduced. This makes it possible to uniformly emit plasma toward a large-surface area workpiece (i.e., evenly expose the large-surface area workpiece to plasma), without using an excessively large plasma generation nozzle.

Preferably, in the plasma generation apparatus of the present invention, the adapter includes a lengthwise plasma chamber in gas communication with the ring-shaped spout. The plasma chamber has a lengthwise opening in one surface thereof.

Preferably, in the plasma generation apparatus of the present invention, the lengthwise spout of the adapter is formed to have an opening area which increases stepwise or continuously in an outward direction. When the spout is formed in a lengthwise shape, a stream (emitting pressure, i.e., flow volume per unit time) of plasma directing outwardly is apt to be deteriorated, and a temperature of the plasma is also apt to be lowered. Thus, instead of simply forming the lengthwise spout to have a constant width, the lengthwise spout is formed to have an opening area increasing stepwise or continuously so as to increase an amount of plasma to be emitted, toward an outward side of the lengthwise spout. This makes it possible to further uniformly emit plasma along an overall length of the lengthwise spout.

Preferably, the plasma generation apparatus of the present invention further comprises a heat-radiation fin provided around a connection portion between the plasma generation nozzle and the adapter. In this preferred embodiment, even if the adapter is heated to a high temperature by storing plasma gas therein, the heat-radiation fin can suppress propagation of the heat toward the plasma generation nozzle.

Preferably, the plasma generation apparatus of the present invention further comprises a heater attached to the adapter to pre-heat the adapter. In this preferred embodiment, the adapter can be pre-heated to facilitate plasma ignition without detaching the adapter from the nozzle, and uniformly emit plasma just after ignition.

Preferably, the plasma generation apparatus of the present invention further comprises a temperature detection element adapted to detect a temperature of the adapter. In this preferred embodiment, a temperature of the adapter can be monitored and detected, and the detection result can be used as a control parameter.

More preferably, this plasma generation apparatus further comprises a control section operable, based on a detection result of the temperature detection element, to control an amount of the gas to be supplied to the plasma generation nozzle, and/or a power of the microwave. In this preferred embodiment, a state of plasma generation can be estimated from a temperature of the adapter to accurately adjust plasma to be output.

Preferably, the plasma generation apparatus of the present invention further comprises a light detection element adapted to detect light emitted by the plasmatized gas within the adapter. In this preferred embodiment, even if plasma emission cannot be visually checked due to attachment of the adapter, a state of plasma emission can be monitored and detected, and the detection result can be used as a control parameter.

More preferably, in this plasma generation apparatus, the adapter includes a lengthwise plasma chamber in gas communication with the ring-shaped spout, and the plasma chamber has a lengthwise opening in one surface thereof, wherein the light detection element is operable to detect light emitted by the plasmatized gas within the plasma chamber.

More preferably, the above plasma generation apparatus further comprises a control section operable, based on a detection result of the light detection element, to control an amount of the gas to be supplied to the plasma generation nozzle, and/or a power of the microwave. In this preferred embodiment, a state of plasma generation can be estimated from the detection result of the light detection element to accurately adjust plasma to be output.

A plasma generation apparatus according to a second aspect of the present invention comprises: a microwave generation section adapted to generate a microwave; a gas supply section adapted to supply a gas to be plasmatized; a plurality of plasma generation nozzles each of which includes an inner electrode adapted to receive the microwave, and an outer electrode concentrically disposed outside the inner electrode, wherein each of the plasma generation nozzles is adapted to plasmatize the gas supplied from the gas supply section thereinto, based on energy of the microwave, and emit the plasmatized gas from a distal end thereof; a waveguide adapted to propagate the microwave generated by the microwave generation section, wherein the plasma generation nozzles are attached to the waveguide in such a manner as to be arranged in an array; and an adapter attached to at least one of the distal ends of the plasma generation nozzles. In this plasma generation apparatus, the inner and outer electrodes in each of the plasma generation nozzles are disposed to allow a glow discharge to be induced therebetween so as to plasmatize the gas in a space defined therebetween, and, according to a new supply of the gas into the space, emit the plasmatized gas under atmospheric pressures from a ring-shaped spout of the space in the distal end of the plasma generation nozzle, and the adapter is adapted to convert the ring-shaped spout to a lengthwise spout thereof.

In the plasma generation apparatus set forth in the second aspect of the present invention, the array of plasma generation nozzles are mounted to the waveguide, and the adapter is adapted to convert the ring-shaped spout to a lengthwise spout thereof are attached to the distal ends of the plasma generation nozzles. This makes it possible to uniformly emit plasma to a large-surface area workpiece, using the plurality of plasma generation nozzles.

Preferably, in the plasma generation apparatus set forth in the second aspect of the present invention, the adapter is provided to the plasma generation nozzles, respectively. If two or more of the plasma generation nozzles are attached to one adapter to share a common spout, a region having a low plasma density is likely to occur due to collision between respective plasma flows from the adjacent plasma generation nozzles. The adapters provided to the respective plasma generation nozzles make it possible to eliminate the problem.

Preferably in this plasma generation apparatus, each of the adapters is attached to a corresponding one of the plasma generation nozzles in such a manner as to be inclined by a predetermined offset angle with respect to a direction of the array of plasma generation nozzles. The arrangement in this preferred embodiment makes it possible to prevent plasmas emitted from respective longitudinal ends of the lengthwise spouts of the adjacent plasma generation nozzles from colliding with each other so as to suppress the occurrence of lowing in plasma density around the longitudinal ends.

Preferably, in the plasma generation apparatus set forth in the second aspect of the present invention, the plasma generation nozzles are grouped into two or more arrays disposed in parallel relation to each other, wherein the respective arrays of plasma generation nozzles are disposed in displaced relation to each other, when viewed from a direction orthogonal to a direction of each of the arrays of plasma generation nozzles, in a plane defined by the arrays of plasma generation nozzles, and the adapter is attached to at least one of the plasma generation nozzles, in such a manner that the lengthwise spout has a longitudinal axis positioned approximately parallel to the array direction.

Alternatively, the plasma generation nozzles may be disposed on a single straight line, and the lengthwise spouts of the adapters may have longitudinal axes positioned approximately parallel to the straight line and alternately offset in a direction orthogonal to the straight line.

Each of the arrangements in these preferred embodiments also makes it possible to prevent plasmas emitted from respective longitudinal ends of the lengthwise spouts of the adjacent plasma generation nozzles from colliding with each other.

Preferably, in the plasma generation apparatus set forth in the second aspect of the present invention, adjacent ones of the adapters are positioned to allow respective longitudinal ends of the lengthwise spouts of the adjacent adapters to overlap each other, when viewed from a direction orthogonal to a direction of the array of plasma generation nozzles, in a plane defined by the array of plasma generation nozzles. While a plasma density is apt to be relatively lowered in the longitudinal end of the lengthwise spout, the arrangement in this preferred embodiment, which allows respective longitudinal ends of the lengthwise spouts of the adjacent adapters to overlap each other, makes it possible to provide a substantially uniform plasma density over the direction of the array of plasma generation nozzles.

A workpiece processing apparatus according to a third aspect of the present invention is designed to expose a workpiece to plasma so as to subject the workpiece to a predetermined processing. The workpiece processing apparatus comprises: a plasma generation apparatus adapted to emit a plasmatized gas in a predetermined direction relative to the workpiece; and a moving mechanism adapted to cause relative movement between the workpiece and the plasma generation apparatus, in a plane intersecting the emitting direction of the plasmatized gas. The plasma generation apparatus includes: a microwave generation section adapted to generate a microwave; a gas supply section adapted to supply a gas to be plasmatized; a plasma generation nozzle which includes an inner electrode adapted to receive the microwave, and an outer electrode disposed outside the inner electrode in concentric and spaced-apart relation thereto, wherein the plasma generation nozzle is adapted to plasmatize the gas supplied from the gas supply section thereinto, based on energy of the microwave, and eject the plasmatized gas from a distal end thereof; and an adapter attached to the distal end of the plasma generation nozzle. In the plasma generation apparatus, the inner and outer electrodes of the plasma generation nozzle are concentrically disposed to allow a glow discharge to be induced therebetween so as to plasmatize the gas in a space defined therebetween, and, according to a new supply of the gas into the space, emit the plasmatized gas under atmospheric pressures from a ring-shaped spout of the space in the distal end of the plasma generation nozzle, and the adapter is adapted to convert the ring-shaped spout to a lengthwise spout thereof.

Preferably, the workpiece processing apparatus set forth in the third aspect of the present further comprises a temperature detection element adapted to detect a temperature of the adapter, and a control section operable, based on a detection result of the temperature detection element, to control an amount of the gas to be supplied to the plasma generation nozzle, and/or a power of the microwave.

Alternatively, the workpiece processing apparatus may further comprise a light detection element adapted to detect light emitted by the plasmatized gas within the adapter, and a control section operable, based on a detection result of the light detection element, to control an amount of the gas to be supplied to the plasma generation nozzle, and/or a power of the microwave.

A workpiece processing apparatus according to a fourth aspect of the present invention is designed to expose a workpiece to plasma so as to subject the workpiece to a predetermined processing. The workpiece processing apparatus comprises: a plasma generation apparatus adapted to emit a plasmatized gas in a predetermined direction relative to the workpiece; and a moving mechanism adapted to cause relative movement between the workpiece and the plasma generation apparatus, in a plane intersecting the emitting direction of the plasmatized gas. The plasma generation apparatus includes: a microwave generation section adapted to generate a microwave; a gas supply section adapted to supply a gas to be plasmatized; a plurality of plasma generation nozzles each of which includes an inner electrode adapted to receive the microwave, and an outer electrode disposed concentrically outside the inner electrode, wherein each of the plasma generation nozzles is adapted to plasmatize the gas supplied from the gas supply section thereinto, based on energy of the microwave, and emit the plasmatized gas from a distal end thereof; a waveguide adapted to propagate the microwave generated by the microwave generation section, wherein the plasma generation nozzles are attached to the waveguide in such a manner as to be arranged in an array; and an adapter attached to at least one of said distal ends of said plasma generation nozzles. In the plasma generation apparatus, said inner and outer electrodes in each of said plasma generation nozzles are disposed to allow a glow discharge to be induced therebetween so as to plasmatize said gas in a space defined therebetween, and, according to a new supply of said gas into said space, emit said plasmatized gas under atmospheric pressures from a ring-shaped spout of said space in said distal end of said plasma generation nozzle, and said adapter is adapted to convert said ring-shaped spout to a lengthwise spout thereof.

The workpiece processing apparatus set forth in each of the third and fourth aspects of the present invention makes it possible to allow a large-surface area workpiece to be evenly exposed to plasma, even using a low-cost, easily-controlled, small-diameter plasma generation nozzle, without using an excessively large plasma generation nozzle.

This application is based on patent application Nos. 2006-233710, 2006-233711 and 2006-233712 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A plasma generation apparatus comprising:
a microwave generation section adapted to generate a microwave;
a gas supply section adapted to supply a gas to be plasmatized;
a plasma generation nozzle which includes an inner electrode adapted to receive said microwave, and an outer electrode concentrically disposed outside said inner electrode, said plasma generation nozzle being adapted to plasmatize said gas supplied from said gas supply section thereinto, based on energy of said microwave, and emit said plasmatized gas from a distal end thereof; and
an adapter attached to said distal end of said plasma generation nozzle,
wherein:
said inner and outer electrodes of said plasma generation nozzle are disposed to allow a glow discharge to be induced therebetween so as to plasmatize said gas in a space defined therebetween, and, according to a new supply of said gas into said space, emit said plasmatized gas under atmospheric pressures from a ring-shaped spout of said space in said distal end of said plasma generation nozzle; and
said adapter is adapted to convert said ring-shaped spout to a lengthwise spout thereof.

2. The plasma generation apparatus as defined in claim 1, wherein said adapter includes a lengthwise plasma chamber in gas communication with said ring-shaped spout, said plasma chamber having a lengthwise opening in one surface thereof.

3. The plasma generation apparatus as defined in claim 1, wherein said lengthwise spout of said adapter is formed to have an opening area which increases stepwise or continuously in an outward direction.

4. The plasma generation apparatus as defined in claim 1, which further comprises a heat-radiation fin provided around a connection portion between said plasma generation nozzle and said adapter.

5. The plasma generation apparatus as defined in claim 1, which further comprises a heater attached to said adapter to pre-heat said adapter.

6. The plasma generation apparatus as defined in claim 1, which further comprises a temperature detection element adapted to detect a temperature of said adapter.

7. The plasma generation apparatus as defined in claim 6, which further comprises a control section operable, based on a detection result of said temperature detection element, to control an amount of said gas to be supplied to said plasma generation nozzle, and/or a power of said microwave.

8. The plasma generation apparatus as defined in claim 1, which further comprises a light detection element adapted to detect light emitted by the plasmatized gas within said adapter.

9. The plasma generation apparatus as defined in claim 8, wherein:
said adapter includes a lengthwise plasma chamber in gas communication with said ring-shaped spout, said plasma chamber having a lengthwise opening in one surface thereof; and
said light detection element is operable to detect light emitted by the plasmatized gas within said plasma chamber.

10. The plasma generation apparatus as defined in claim 8, wherein which further comprises a control section operable, based on a detection result of said light detection element, to control an amount of said gas to be supplied to said plasma generation nozzle, and/or a power of said microwave.

11. A plasma generation apparatus comprising:
a microwave generation section adapted to generate a microwave;
a gas supply section adapted to supply a gas to be plasmatized;
a plurality of plasma generation nozzles each of which includes an inner electrode adapted to receive said microwave, and an outer electrode concentrically disposed outside said inner electrode, each of said plasma generation nozzles being adapted to plasmatize said gas supplied from said gas supply section thereinto, based on energy of said microwave, and emit said plasmatized gas from a distal end thereof;
a waveguide adapted to propagate said microwave generated by said microwave generation section, wherein said plasma generation nozzles are attached to said waveguide in such a manner as to be arranged in an array; and
an adapter attached to at least one of said distal ends of said plasma generation nozzles,
wherein:
said inner and outer electrodes in each of said plasma generation nozzles are disposed to allow a glow discharge to be induced therebetween so as to plasmatize said gas in a space defined therebetween, and, according to a new supply of said gas into said space, emit said plasmatized gas under atmospheric pressures from a ring-shaped spout of said space in said distal end of said plasma generation nozzle; and
said adapter is adapted to convert said ring-shaped spout to a lengthwise spout thereof.

12. The plasma generation apparatus as defined in claim 11, wherein said adapter is provided to said plasma generation nozzles, respectively.

13. The plasma generation apparatus as defined in claim 12, wherein each of said adapters is attached to a corresponding one of said plasma generation nozzles in such a manner as to be inclined by a predetermined offset angle with respect to a direction of said array of plasma generation nozzles.

14. The plasma generation apparatus as defined in claim 11, wherein:
said plasma generation nozzles are grouped into two or more arrays disposed in parallel relation to each other, wherein said respective arrays of plasma generation nozzles are disposed in displaced relation to each other, when viewed from a direction orthogonal to a direction of each of said arrays of plasma generation nozzles, in a plane defined by said arrays of plasma generation nozzles; and
said adapter is attached to at least one of said plasma generation nozzles, in such a manner that said lengthwise spout has a longitudinal axis positioned approximately parallel to said array direction.

15. The plasma generation apparatus as defined in claim 12, wherein:
said plasma generation nozzles are disposed on a single straight line; and
said lengthwise spouts of said adapters have longitudinal axes positioned approximately parallel to said straight line and alternately offset in a direction orthogonal to said straight line.

16. The plasma generation apparatus as defined in claim 12, wherein adjacent ones of said adapters are positioned to allow respective longitudinal ends of the lengthwise spouts of said adjacent adapters to overlap each other, when viewed from a direction orthogonal to a direction of said array of plasma generation nozzles, in a plane defined by said array of plasma generation nozzles.

17. A workpiece processing apparatus for irradiating a workpiece to plasma so as to subject said workpiece to a predetermined processing, comprising:
a plasma generation apparatus adapted to emit a plasmatized gas in a predetermined direction relative to said workpiece; and
a moving mechanism adapted to cause relative movement between said workpiece and said plasma generation apparatus, in a plane intersecting the emitting direction of said plasmatized gas,
wherein said plasma generation apparatus includes:
a microwave generation section adapted to generate a microwave;
a gas supply section adapted to supply a gas to be plasmatized;
a plasma generation nozzle which includes an inner electrode adapted to receive said microwave, and an outer electrode concentrically disposed outside said inner electrode, said plasma generation nozzle being adapted to plasmatize said gas supplied from said gas supply section thereinto, based on energy of said microwave, and emit said plasmatized gas from a distal end thereof; and
an adapter attached to said distal end of said plasma generation nozzle,
wherein:
said inner and outer electrodes of said plasma generation nozzle are disposed to allow a glow discharge to be induced therebetween so as to plasmatize said gas in a space defined therebetween, and, according to a new supply of said gas into said space, emit said plasmatized gas under atmospheric pressures from a ring-shaped spout of said space in said distal end of said plasma generation nozzle; and
said adapter is adapted to convert said ring-shaped spout to a lengthwise spout thereof.

18. The workpiece processing apparatus as defined in claim 17, which further comprises:
a temperature detection element adapted to detect a temperature of said adapter; and
a control section operable, based on a detection result of said temperature detection element, to control an amount of said gas to be supplied to said plasma generation nozzle, and/or a power of said microwave.

19. The workpiece processing apparatus as defined in claim 17, which further comprises:
a light detection element adapted to detect light emitted by the plasmatized gas within said adapter; and
a control section operable, based on a detection result of said light detection element, to control an amount of said gas to be supplied to said plasma generation nozzle, and/or a power of said microwave.

20. A workpiece processing apparatus for irradiating a workpiece to plasma so as to subject said workpiece to a predetermined processing, comprising:
a plasma generation apparatus adapted to emit a plasmatized gas in a predetermined direction relative to said workpiece; and
a moving mechanism adapted to cause relative movement between said workpiece and said plasma generation apparatus, in a plane intersecting the emitting direction of said plasmatized gas,
wherein said plasma generation apparatus includes:
a microwave generation section adapted to generate a microwave;
a gas supply section adapted to supply a gas to be plasmatized;
a plurality of plasma generation nozzles each of which includes an inner electrode adapted to receive said microwave, and an outer electrode concentrically disposed outside said inner electrode, each of said plasma generation nozzles being adapted to plasmatize said gas supplied from said gas supply section thereinto, based on energy of said microwave, and emit said plasmatized gas from a distal end thereof;
a waveguide adapted to propagate said microwave generated by said microwave generation section, wherein said plasma generation nozzles are attached to said waveguide in such a manner as to be arranged in an array; and
an adapter attached to at least one of said distal ends of said plasma generation nozzles,
wherein:
said inner and outer electrodes in each of said plasma generation nozzles are disposed to allow a glow discharge to be induced therebetween so as to plasmatize said gas in a space defined therebetween, and, according to a new supply of said gas into said space, emit said plasmatized gas under atmospheric pressures from a ring-shaped spout of said space in said distal end of said plasma generation nozzle; and
said adapter is adapted to convert said ring-shaped spout to a lengthwise spout thereof.
